(19) United States
(12) Patent Application Publication
(10) Pub. No.: US 2023/0276793 A1
(43) Pub. Date: Sep. 7, 2023

(54) METHOD TO DEVELOP ENGINEERED NANOBUBBLES FOR SANITATION

(71) Applicant: Virginia Tech Intellectual Properties, Inc., Blacksburg, VA (US)

(72) Inventors: Reza Ovissipour, Yorktown, VA (US); Setareh Shiroodi, Yorktown, VA (US); Michael Hans Schwarz, Virginia Beach, VA (US)

(21) Appl. No.: 17/912,460

(22) PCT Filed: Dec. 3, 2020
(86) PCT No.: PCT/US20/63059

§ 371 Date: Sep. 16, 2022

Related U.S. Application Data
(60) Provisional application No. 63/027,164, filed on May 19, 2020.
(60) Provisional application No. 62/991,539, filed on Mar. 18, 2020.

(51) Int. Cl. A01N 25/34; A01N 25/22; A01N 59/00

(52) U.S. Cl. CPC A01N 25/34; A01N 25/22; A01N 59/00

(57) ABSTRACT

This invention is generally related to develop engineered nanobubbles to deliver sanitizers, and antimicrobials to microorganisms in water, contact surfaces as biofilm, wound, and food material, as well as synergetic combinations development with other processing technologies. The invention provides opportunity for reducing pathogenic bacteria rapidly and more effectively, with less chemical application.

### CROSS-REFERENCE TO RELATED APPLICATIONS

This application relies on the disclosure of and claims priority to and the benefit of the filing date of U.S. Provisional Application No. 63/027,164, filed on May 19, 2020 and of U.S. Provisional Application No. 62/991,539, filed on Mar. 18, 2020, the disclosures of each of which are hereby incorporated by reference herein in their entireties.

### BACKGROUND OF THE INVENTION

### Field of the Invention

Microorganisms are biological entities that exist in the environment, water, and food, and they can be beneficial or hazardous to humans, and can be transmitted to humans from food and water. According to the Centers for Disease Control and Prevention, among 31 foodborne pathogens, five are the deadliest bacteria which can cause death including, Salmonella, Listeria monocytogenes, Toxoplasma gondii, Norovirus, and Campylobacter. Collectively, these bacteria cause 48 million illnesses, 128,000 hospitalizations, and 3,000 deaths in the U.S. costing $15 billion annually.

### Description of Related Art

Sanitation is an important component of good agricultural practices for preventing cross-contamination of fresh produce during production. Many of the foodborne diseases resulting from minimally processed products can be traced back to cross-contamination of food products from food contact surfaces. Any surface that comes into contact with food, either directly or indirectly, is a food contact surface and must be cleaned and sanitized to prevent cross-contamination and biofilm formation. Bacteria biofilm formation in food processing facilities is recognized as one of the major food safety concerns. Biofilms can adhere to different types of food contact surfaces, including stainless-steel, plastic, glass, and wood, causing bacterial foodborne disease outbreaks, lowering shelf life of the food products, and causing numerous economic losses (see Winkelströter, L. K., dos Reis Teixeira, F. B., Silva, E. P., Alves, V. F. & De Martinis, E. C. P. Unraveling microbial biofilms of importance for food microbiology. Microbial Ecology 68(1), 35-46 (2014); Hall-Stoodley, L., Costerton, J. W. & Stoodley, P. Bacterial biofilms: from the natural environment to infectious diseases. Nature Rev. Micro. 2(2), 95-108 (2004); Jang, H., Rusconi, R. & Stocker, R. Biofilm disruption by an air bubble reveals heterogeneous age-dependent detachment patterns dictated by initial extracellular matrix distribution. npj Biofi. Microbio. 3(1), 1-7 (2017); Powell, L. C. et al. Targeted disruption of the extracellular polymeric network of Pseudomonas aeruginosa biofilms by alginate oligosaccharides. npj Biofilms and Microbiomes 4(1), 1-10 (2018)).

Important potential sources of bacterial contamination also include fisheries and aquaculture, which are growing industries. Vibrio spp. are natural inhabitants of estuaries and coastal marine environments. Another important aquatic microorganism is Aeromonas hydrophila, which can cause disease in fish and humans. This microorganism is a major problem for the aquaculture industry, affecting seafood quality and causing severe losses for production and marketing (see Vivekanandhan, G., Hatha, A. A. M., & Lakshmanaperumalsamy, P. (2005). Prevalence of Aeromonas hydrophila in fish and prawns from the seafood market of Coimbatore, South India. Food Microbiology, 22(1), 133-137).

Since most fresh produce is consumed raw, there is a potential for cross-contamination and transfer of pathogenic bacteria from aquaculture water to edible parts of plants (see Ovissipour, M., Rasco, B., Bledsoe, G., & Shiroodi, S. (2019). A Guide to the Aquaponics Food Safety Plan Development: Green Aquaponics LLC as a Model. Virginia Cooperative Extension, FST-302P/VSG-18-P). Controlling fish diseases and foodborne pathogens in recirculating aquaculture systems and aquaponics using antibiotics, chemical sanitizers, and pesticides is challenging due to the sensitivity of the microbial community in biofilters (which oxidize ammonia to non-toxic nitrate), chemical residue concerns in both fish and plants, and regulatory stand points.

Bacterial biofilms are associated with a self-produced slimy matrix, which includes up to 90% of the biofilm biomass, composed of extracellular polymeric substances (EPSs) containing polysaccharides, proteins, lipids, and extracellular DNA (eDNA), which adhere to each other and form a biofilm (see Zhao, X., Zhao, F., Wang, J. & Zhong, N. Biofilm formation and control strategies of foodborne pathogens: food safety perspectives. RSC Advances 7(58), 36670-36683, 2017). Compared to planktonic cells, biofilms are more resistant to environmental stresses and disinfectants; therefore, decontamination of biofilms in food processing facilities is an important food safety challenge (see Kim, H., Ryu, J. H. & Beuchat, L. R. Attachment of and biofilm formation by Enterobacter sakazakii on stainless steel and enteral feeding tubes. Appl. Environ. Micro. 72(9), 5846-5856 (2006); Bae, Y. M., Baek, S. Y., & Lee, S. Y. (2012). Resistance of pathogenic bacteria on the surface of stainless steel depending on attachment form and efficacy of chemical sanitizers. Int. J. Food Micro. 153(3), 465-473, (2012)).

Antimicrobial activity of commonly used sanitizers including chlorine, hydrogen peroxide, quaternary ammonium (QUATS), sodium hypochlorite, and peracetic acid, which have strong antimicrobial properties against planktonic microorganisms, can be limited against surface attached microbes due to rapid depletion in concentration and activity upon reactions with organic matter, complexity of structural features of the plant surfaces, and factors related to EPS in biofilms (see Hughes, G. & Webber, M. A. Novel Approaches to the Treatment of Bacterial Biofilm Infections. Br. J. Pharmacol. 174, 2237-2246, (2017)). In addition, current agricultural practices and sanitation using chlorine, peracetic acid, and ozone can only reduce 1-2 log of the bacteria on the surface of food materials, including fresh produce and fruits, due to the non-specific reactivity of sanitizers with plant organic content and the complexity of surface physicochemical properties which may protect bacteria from contact with conventional sanitizers, thereby limiting the efficacy of conventional sanitizers.

Both acidic and neutral electrolyzed water (AEW and NEW) have been successfully applied in food and the seafood industries as a novel and environmentally friendly technology. Antimicrobial and antibiofilm properties of EW have been studied by prior researchers who successfully applied acidic EW for removing L. monocytogenes, E coli, and V. parahaemolyticus biofilms (see Han, 2017; Shiroodi, S. G., Ovissipour, R., Ross, C. F. & Rasco, B. A. Efficacy of electrolyzed oxidizing water as a pretreatment method for reducing Listeria monocytogenes contamination in cold-smoked Atlantic salmon (Salmo salar). Food Control 60, 401-407 (2016); Ovissipour, R. et al. Efficacy of acidic and alkaline electrolyzed water for inactivating Escherichia coli 0104:H4, Listeria monocytogenes, Campylobacter jejuni, Aeromonas hydrophila, and Vibrio parahaemolyticus in cell suspensions. Food Control 53, 117-123 (2015); Ovissipour, R., Shiroodi, S. G., Rasco, B., Tang, J. & Sablani, S. S. Electrolyzed water and mild-thermal processing of Atlantic salmon (Salmo salar): Reduction of Listeria monocytogenes and changes in protein structure. Int. J. Food Micro. 276:10-19 (2018)).

Compared to acidic electrolyzed water (AEW), NEW typically has less side effects on food quality due to its slightly acidic to neutral pH (5-6.5). Due to the available form of chlorine (hypochlorous acid) in NEW, it also has greater antimicrobial properties (see Cui, X., Shang, Y., Shi, Z., Xin, H., & Cao, W. Physicochemical properties and bactericidal efficiency of neutral and acidic electrolyzed water under different storage conditions. J. Food Eng. 91(4), 582-586 (2009)).

Recently, nanobubbles (NB) (also known as ultrafine bubbles) have gained researchers' attention due to their unique properties in wide fields of advanced science and technology including engineering, medical, agricultural, and food sectors (see Shen, Y., Longo, M. L. & Powell, R. L. Stability and rheological behavior of concentrated monodisperse food emulsifier coated microbubble suspensions. J. Coll. Interf Sci. 327(1), 204-210 (2008); Zhu, Z., Sun, D. W., Zhang, Z., Li, Y. & Cheng, L. Effects of micro-nano bubbles on the nucleation and crystal growth of sucrose and maltodextrin solutions during ultrasound-assisted freezing process. LWT 92, 404-411 (2018); and Phan, K. K., Truong, T., Wang, Y. & Bhandari. B. Nanobubbles: Fundamental characteristics and applications in food processing. Trend. Food Sci. Tech. 95, 118-130 (2019)). In particular, antimicrobial and antibiofilm properties of nanobubbles have been shown by a few studies on Burkholderia multivorans, Pseudomonas aeruginosa and Staphylococcus aureus using NB generated by laser and gold nanoparticles (See Teirlinck, E. et al. Laser-induced vapour nanobubbles improve drug diffusion and efficiency in bacterial biofilms. Nature Communications 9(1), 4518 (2018); and Teirlinck, E. et al. Laser-induced vapor nanobubbles improve diffusion in biofilms of antimicrobial agents for wound care. Biofilm 1, 100004 (2019)). Additionally, researchers have studied the viable bacterial count on Chinese cabbage using ultrafine bubbles in combination with EW (see Ushida et al., 2017), Bovine serum albumin using nanobubbles (see Zhu et al., 2016), periodonto-pathogenic bacteria, Porphyromonas gingivalis and Aggregatibacter actinomycetemcomitans using ozone NB (see Hayakumo et al., 2014), P. aeruginosa biofilm and carbohydrate, protein and fat on SS using microbubbles (see Burfoot, D., Limburn, R. & Busby, R. Assessing the effects of incorporating bubbles into the water used for cleaning operations relevant to the food industry. Int. J. Food Sci. Tech. 52(8), 1894-1903 (2017)).

NB exist in both bulk and interface, and due to their unique properties, including nano-size diameter, negative surface charge, and Brownian motion, they develop a stable form of bubbles resulting in supersaturated solutions (see Zhu, J. et al. Cleaning with bulk nanobubbles. Langmuir 32(43), 11203-11211 (2016); Ushikubo, F. Y. et al. Evidence of the existence and the stability of nano-bubbles in water. Colloids and Surfaces A: Physicochem. Eng. Aspects 361(1-3):31-37 (2010)).

Antibiofilm and antimicrobial properties of NB are strongly correlated to the physical properties of the NB (including high gas transfer capacity), generation of free radicals including (OH·), high energy release by bursting and collapsing of bubbles, and the potential generation of reactive oxygen species (ROS) (see Ushikubo et al., 2010; Ghadimkhani et al., 2016; Liu, S., Oshita, S. & Makino, Y. Stimulating effect of nanobubbles on the reactive oxygen species generation inside barley seeds as studied by the microscope spectrophotometer. In Proceedings. Int. Conf. of Agric. Eng., Zurich (pp. 06-10) (2014); Demangeat, J. L. Gas nanobubbles and aqueous nanostructures: the crucial role of dynamization. Homeopathy 104(02), 101-115 (2015).)

Hydroxyl radicals possess a significantly higher reactivity with organic materials in water, indicating high potential for removing organic materials (see Phan et al., 2019), which can be used for removing biofilm EPS. EPS makes up about 80% of the biofilm dry mass mainly containing carbohydrates and proteins (see Liu, Y., Li, J., Qiu, X. & Burda, C. Bactericidal activity of nitrogen-doped metal oxide nanocatalysts and the influence of bacterial extracellular polymeric substances (EPS). J. Photochem. Photobio. A: Chemistry 190(1), 94-100 (2007)). EPS is responsible for biofilm properties including density, porosity and hydrophobicity. During the sanitation operation, an effective sanitizer should break up or dissolve biofilm EPS so that the disinfectant can access the viable cells (see Shen, Y. Response of simulated drinking water biofilm mechanical and structural properties to long-term disinfectant exposure. Environ. Sci. Tech. 50(4), 1779-1787 (2016)). Biofilm removal from surfaces depends strongly on EPS degradation rather than removal of intracellular compounds (see Han, Q. et al. Removal of foodborne pathogen biofilms by acidic electrolyzed water. Front Micro. 8, e988 (2017)). Zhou et al. (2016) showed that the presence of ozone reduced EPS content of microbial biofilms. Han et al. (2017) also reported that acidic EW disrupted microbial biofilms EPS.

Cleaning and preventing contamination of hydrophilic and hydrophobic surfaces using NB have been shown by bovine serum albumin (BSA) indicating the strong surfactant properties of NB (see Zhu et al., 2016), and organic material (Humic acid) on ceramic (see Ghadimkhani et al., 2016). The incorporation of NB into membrane filtration is an emerging technology for decreasing and preventing membrane or surface fouling because of the high mass transfer ability of NB (see Zhu et al., 2016; Wu et al., 2008).

Preventing organic materials adhesion to surfaces by NB has been shown in prior studies (see Zhu et al., 2016). Several studies have suggested that the cell surface hydrophobicity may have an important role in bacterial adhesion to surfaces (see Huang et al., 2017; Gibbons, R. J. & Etherden, I. Comparative hydrophobicities of oral bacteria and their adherence to salivary pellicles. Infec. Immun. 41(3), 1190-1196 (1983)). It has also been shown that L. innocua cells have a negative surface charge (see Gibbons et al., 1983). Moreover, the zeta potential results showed that NB in solutions are normally negatively charged at the gas-water interface, resulting in surface tension and contact angle reduction, and act as surfactants (see Zhu et al., 2018).

Further, it has been shown by prior studies that treating medical grade poly vinyl chloride with oxygen resulted in a 70% reduction in bacterial adhesion for four strains of P. aeruginosa (see Balazs, D. J. et al. Surface modification of PVC endotracheal tubes by oxygen glow discharge to reduce bacterial adhesion. Surf Inter. Anal. 35(3), 301-309 (2003)), but this reduction by surface oxygenation was not sufficient to prevent colonization of bacteria (see Triandafillu, K. et al. Adhesion of Pseudomonas aeruginosa strains to untreated and oxygen-plasma treated poly (vinyl chloride) (PVC) from endotracheal intubation devices. Biomaterials April 24(8), 1507-1518 (2003)). On both hydrophobic and hydrophilic surfaces, bovine serum albumin adhesion was reduced significantly by NB, which might be due to the protein adsorbing to the NB in bulk due to the negative charge of NB (see Zhu et al., 2018). Antifouling and cleaning properties of NB have been suggested by prior researches on membrane filters and ceramic (see Ghadimkhani et al., 2016).

Additionally, NB technology has been used for different applications including:
surface cleaning (see Liu, G., Wu, Z. & Craig, V. S. Cleaning of protein-coated surfaces using nanobubbles: An investigation using a quartz crystal microbalance. J. Phys. Chem. C 112, 16748-16753 (2008); Wu, Z. et al. Cleaning using nanobubbles: defouling by electrochemical generation of bubbles. Journal of colloid and interface science. 328(1), 10-14 (2008); Ghadimkhani, A., Zhang, W. & Marhaba, T. Ceramic membrane defouling (cleaning) by air Nano Bubbles. Chemosphere 146, 379-384 (2016));
dental hygiene and removing dental bacteria (see Hayakumo, S. et al. Effects of ozone nano-bubble water on periodontopathic bacteria and oral cells-in vitro studies. Sci. Tech. Adv. Mater. 15(5), 055003 (2014));
drug diffusion into biofilms and wound biofilm cleaning (see Teirlinck et al., 2018, 2019);
detaching bacteria from fresh produce (see Ushida, A. et al. Antimicrobial effectiveness of ultra-fine ozone-rich bubble mixtures for fresh vegetables using an alternating flow. J. Food Eng. 206, 48-56 (2017));
enhancing plant and aquatic organism performance in hydroponics, aquaponics, and aquaculture systems (see Ebina, K. et al. Oxygen and air nanobubble water solution promote the growth of plants, fishes, and mice. PLoS One 8(6), e65339 (2013));
long term storage of fish (see Wang, X., Zhang, H., Yang, F., Wang, Y. & Gao, M. Long-term storage and subsequent reactivation of aerobic granules. Bioresour. Technol. 99(17), 8304-8309 (2008));
inactivation of norovirus (see Kozima, H., Mukai, Y., Ransangan, J. & Senoo, S. Feasibility study of applications of micro-bubbles for aquaculture. In: Proceedings of the International Conference on Coastal Oceanography and Sustainable Marina Aquaculture, Confluence & Synergy, pp. 220-223 (2006));
removing organic materials (see Akuzawa et al. Study on cleaning of pipe inner wall by micro-bubble flow. Jpn. J Multiph. Flow 24(4), 454-461 (2010); Zhou, Q. et al. Enhanced stable long-term operation of biotrickling filters treating VOCs by low-dose ozonation and its affecting mechanism on biofilm. Chemosphere 162, 139-147 (2016));
and water treatments (see Gurung, A., Dahl, O. & Jansson, K. The fundamental phenomena of nanobubbles and their behavior in wastewater treatment technologies. Geosystem Eng. 19(3), 133-142 (2016)).

However, antibiofilm and antimicrobial properties of NB alone and in combination with other environmentally friendly sanitizers have not been studied extensively, and only a few studies have investigated antimicrobial properties of nanobubbles alone or in combination with chemicals and other non-thermal processing such as ultrasound (see Kozima et al., 2006; Ushida et al., 2017; Shiroodi, S., Schwarz, M., Nitin, N., & Ovissipour, R. (2020, under review). Efficacy of nanobubbles in removing biofilms formed by Escherichia coli O157:H7, Vibrio parahaemolyticus, and Listeria innocua. Biofilm, under review).

Ultrasound has successfully reduced bacterial populations, when it was applied with chemical sanitizers (Ajlouni, S., Sibrani, H., Premier, R., & Tomkins, B. (2006). Ultrasonication and fresh produce (Cos lettuce) preservation. Journal of Food Science, 71(2), 62-68; Huang, K., Wrenn, S., Tikekar, R., & Nitin, N. (2018). Efficacy of decontamination and a reduced risk of cross-contamination during ultrasound-assisted washing of fresh produce. Journal of Food Engineering, 224, 95-104). Ultrasound alone and in combination with UV-C was applied for inactivating heterotrophic bacteria in intensive aquaculture system which did not result in a significant reduction (Lakeh, A. A. B., Kloas, W., Jung, R., Ariav, R. A., & Knopf, K. (2013). Low frequency ultrasound and UV-C for elimination of pathogens in recirculating aquaculture systems. Ultrasonics Sonochemistry, 20(5), 1211-1216.)

Antibiofilm and antimicrobial properties of nanobubbles are strongly correlated to the physical properties of the nanobubbles (including high gas transfer capacity), generation of free radicals including (OH·), high energy release by bursting and collapsing of bubbles, and the potential generation of reactive oxygen species (ROS) (Demangeat, 2015; Ghadimkhani et al., 2016). Due to the high internal pressure in nanobubbles, when they burst on the surface of bacteria because of the ultrasound, they release high surface energy, allowing conversion of 02 to ROS and cause surface cavitation resulting in bacterial inactivation (Phan et al., 2019). Furthermore, hydroxyl radicals can be generated in the water as a result of nanobubbles collapse (Demangeat, 2015). Hydroxyl radical generation and shock waves from collapse of small cavities are other possible mechanisms for antimicrobial properties of nanobubbles (Teirlinck et al., 2018, 2019).

Due to emerging resistance to conventional antimicrobials, developing new and environmentally friendly sanitizers to control biofilm formation in diverse applications is highly desired.

### SUMMARY OF THE INVENTION

Novel approaches to remove and inactivate diverse microbial biofilms are disclosed herein. To address challenges in sanitation, the inventors have developed three novel approaches. The first includes using nanobubbles technology alone or in combination with low concentrations of commonly used sanitizers for biofilm and bacteria removal and inactivation in water, in solutions (cell-suspensions), and on food surfaces. The second approach is the preparation of engineered nanobubbles by surface modification to deliver antimicrobial compounds to bacteria. The present inventors hypothesize (although not wishing to be bound by any particular theory) that the scientific foundation of this approach is that the bubbles attack and disrupt microbial biofilms, induce oxidative stress, and reduce surface tension, which enhance biofilm removal from surfaces, while the nanobubbles deliver antimicrobial compounds to bacteria. The third approach involves inactivation of bacteria in a combination treatment with nanobubbles and ultrasound.

In embodiments, the present invention provides a rapid method for bacterial reduction and inactivation in cell-suspensions and liquids, biofilms, and/or on surfaces. The technology is based on the use of nanobubbles comprising one or more gases, chemical sanitizers, surfactants, and/or antimicrobial compounds used alone and/or in combination with other processing technologies. The nanobubbles have negative surface charges which can reduce surface tension, release reactive oxygen species, and facilitate surface modification to carry antimicrobial compounds. Nanobubbles generated with different gases such as air, oxygen, CO₂, nitrogen, chlorine dioxide, Octafluoropropane and/or sulfur hexafluoride can be used alone or in combination with one or more sanitizers such as chlorine, peracetic acid, QUATS (quaternary ammonium compounds), hydrogen peroxide, electrolyzed water (EW), which can include neutral, acidic, and/or basic electrolyzed water, imidazole, pesticides, fungicides, herbicides and/or surfactants to inactivate bacteria in suspensions, liquids, biofilms, and/or on surfaces. Nanobubble surfaces also can also be modified and engineered through self-assembly by applying antimicrobial compounds including polymers, phages, peptides, carbohydrates, lipids, fatty acids, alcohols, and ketones.

Applications of this technology include uses in many food production systems where pesticides, chemicals, and antibiotics are not allowed or are not ideal. There is also a market for this technology in medical and dental hygiene. In some embodiments of the invention, since there are no chemicals, this technology could be used for medical device sanitation, wound cleaning, and dental hygiene. Due to their small sizes, nanobubbles can penetrate into cavities, and after applying ultrasonication, can kill bacteria in areas which are not accessible by other sanitizers. In the field of environmental science, the technology can assist with removing oil, off-flavor, and algae from water. In the chemical sanitizers industry, sanitizers with higher efficacy and less chemicals are always of interest. Finally, this technology may be useful to the marine industry, as nanobubbles have antifouling properties which can reduce the attachment of organisms to the facilities in marine environment.

Further uses include use in the food and agriculture industries, such as for harvest equipment sanitation, processing equipment sanitation, sanitation of contact and non-contact food surfaces, water treatment, agricultural water treatment and sanitation prior using for plants, fresh produce sanitation, fruits sanitation, and seafood and meat sanitation. In addition, the invention can be used for removing debris and/or biofilms inside the pipes in food facilities, aquaculture farms, Aquaponics, hydroponics, and in the organic foods industry.

Nanobubbles-ultrasound combinations could also be of significant interest especially to the fresh produce, aquaculture, algae mass production systems in hydroponics, and aquaponics industries as alternative approaches to treat recycling water.

The detailed description below is intended as a description of embodiments of the present invention and it is to be understood that this disclosure is not limited to the particular embodiments described.

### BRIEF DESCRIPTION OF THE DRAWINGS

The technology described herein will be more fully understood by reference to the following drawings which are for illustrative purposes only, and should not be used to limit the invention.

FIG. 1 is an illustration which depicts an exemplary process of inactivating microorganisms according to embodiments of the present invention.

FIG. 2 is an illustration which depicts exemplary engineered nanobubbles as carrier for antimicrobial compounds due to the negative core charge according to an embodiment of the present invention.

FIGS. 3A-C are graphs which depict the number of viable pathogenic bacteria on plastic coupons before and after treating with sanitizers under shear force or no shear condition for about 10 min, V. parahaemolyticus 3-day old biofilm (3A); E. coli O157:H7 4-day old biofilm (3B); and L. innocua 3-day old biofilm (3C). Error bars representing the standard deviation of n=6 values; Asterisks (*) represent the detection limit which is 1 log CFU/cm².

FIGS. 4A-F are graphs which depict the number of viable pathogenic bacteria on plastic and SS coupons before and after treating with sanitizers, V. parahaemolyticus 3-day old biofilm (4A-B); E. coli O157:H7 4-day old biofilm (4C-D); and L. innocua 3-day old biofilm (4E-F). Plastic coupons (4A, 4C, 4E); SS coupons (4B, 4D, 4F). At each experimental time, different letters indicate statistical significance at p<0.05 with error bars representing the standard deviation of n=6 values; Asterisks (*) represent the detection limit which is 1 log CFU/cm². The viable number of bacteria at time zero were 7.9 and 7.82 CFU/cm² for V. parahaemolyticus on plastic and SS coupons; 7.18 and 8.85 CFU/cm² for E. coli on plastic and SS; 6.95 and 7.94 CFU/cm² for L. innocua on plastic and SS.

FIGS. 5A-B are graphs which depict the kinetics of L. innocua adhesion to NB-treated Plastic (5A) and SS coupons (5B). NB-treated (▴), and untreated (·) Plastic and SS coupons were immersed in L. innocua solution for 180 min. Error bars represent standard deviation (n=6).

FIGS. 6A-D are images showing chemical compositions of different L. innocua biofilm EPS. Images were processed based on optical image and Raman maps for different treatments: (6A) Control; (6B) NB; (6C) EW; (6D) EWNB. White background indicates the areas with no biofilms; the shaded regions indicate biofilms with different chemical composition.

FIG. 6E is a graph of SERS spectra showing fingerprints of L. innocua biofilm EPS after treating with different solutions from 1700 to 500 cm⁻¹.

FIGS. 7A-E are Raman maps for different bands at 1635 cm⁻¹ (Amide I; protein), 1090 cm⁻¹ (C—O—C glycosidic link; EPS polysaccharide), 1006 cm⁻¹ (phenylalanine; protein), 788 cm⁻¹ (DNA), and 565 cm⁻¹ (C—O—C glycosidic link; EPS deformation polysaccharide) for L. innocua biofilm EPS treated with different solutions. Max indicates intense and intact biofilm, and min indicates altered and less intense biofilm on SS coupons after treating with different solutions.

FIGS. 8A-B are bar graphs which depict the (8A) V. parahaemolyticus and (8B) A. hydrophila reduction in nanobubbles (NB), ultrasound (US) and nanobubbles+ultrasound (NB+US) at different exposure times. Error bars represent the standard deviation of at least three replicates.

FIG. 8C is a bar graph showing the impact of the synergistic antimicrobial approach (Nanobubble-Ultrasound) on bacterial reduction in liquid.

FIG. 8D is a bar graph depicting the impact of nanobubbles and ultrasonication on bacteria reduction on the surface of food.

### DETAILED DESCRIPTION OF VARIOUS EMBODIMENTS OF THE INVENTION

By way of embodiments of the invention, the inventors have explored: (1) the efficacy of NB compositions, and such compositions in combination with electrolyzed water such as NEW, in removing various microbial biofilms on plastic and stainless-steel coupons; (2) various methods of application of NB and the impact of mechanical shear force on removing microbial biofilms; (3) the molecular changes in biofilms using surface-enhanced Raman spectroscopy (SERS); and (4) the efficacy of preventing growth or killing microbe(s) by exposing the NB compositions to microbe(s) in combination with exposure to ultrasound (Rafeeq, S. et al. Inactivation of Aeromonas hydrophila and Vibrio parahaemolyticus by Curcumin-Mediated Photosensitization and Nanobubble-Ultrasonication Approaches. Foods 2020, 9, 1306 (Sep. 16, 2020).

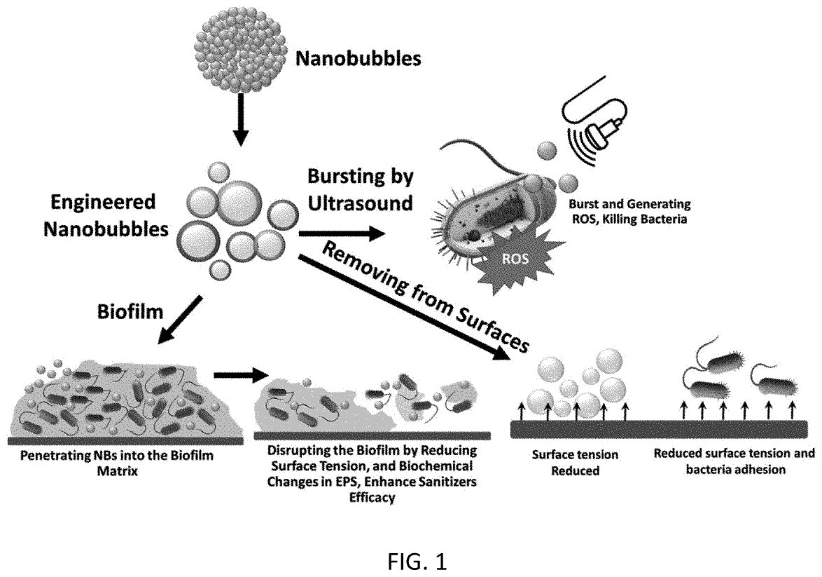

As depicted in FIG. 1, engineered nanobubbles (NB) can be used to deactivate, remove, and/or prevent the adhesion of biofilms, such as on the surface of substrates, and can be used in combination with other techniques (such as ultrasound).

In embodiments of the invention, various substrates are exposed to solutions of nanobubbles for a length of time sufficient to reduce, interfere with, alleviate, remove, and/or prevent growth and/or presence of one or more microbe(s) or biofilm on the substrate. In some embodiments, the length of time is on the order of minutes, such as in the range of about 1 to 10 minutes, for example, 1, 2, 3, 4, 5, 6, 7, 8, 9, or 10 minutes, or any range in between. In some embodiments, the exposure time is a period of time greater than 10 minutes, such as 15, 20, 25, 30, 35, 40, 45, 50, 55, or 60 minutes, or any range in between.

In some embodiments, the solution of nanobubbles comprise one or more sanitizers, such as electrolyzed water. The electrolyzed water can have a pH in the range of about 3 to 7, such as a pH of about 3, 3.5, 4, 4.5, 5, 5.5, 6, 6.5, or 7, or any range in between.

In some embodiments, the solution of nanobubbles can comprise a source of chlorine, such as hypochlorous acid or free chlorine. The source of chlorine can be present in the range of up to about 500 ppm of the composition, such as from 0-500 ppm, or from 10 ppm to 450 ppm, or 25 ppm to 250 ppm, or 50 ppm to 175 ppm, or 150-350 ppm, or 75 to 125 ppm, or 2 to 200 ppm of the composition.

Additionally, such compositions of the invention can be used in methods of preventing growth or of killing one or more microbe(s) by exposing the composition to one or more microbe(s) in combination with exposure to ultrasound.

In another embodiment, fabricated and engineered nanobubbles can deliver drugs, antibiotics and/or antimicrobial polymers to bacteria in cell suspensions, biofilms, and/or surface foods and contact surfaces.

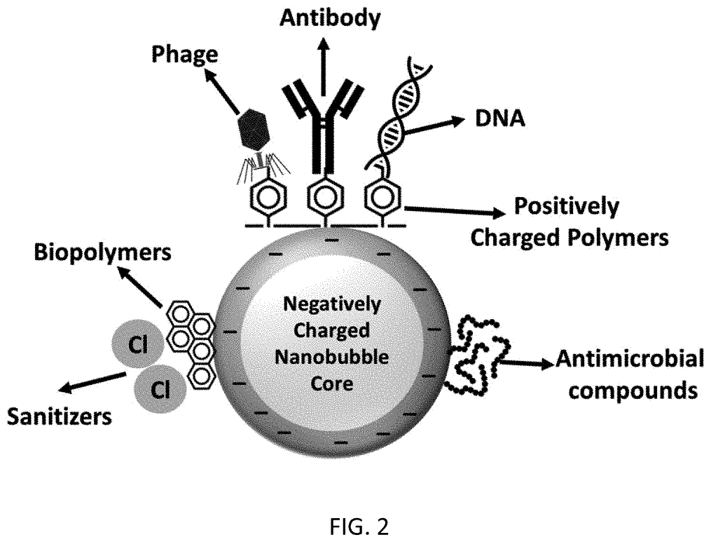

In another embodiment of the invention (FIG. 2), food grade, low cost interfacial active agents can be used to stabilize compositions comprising nanobubbles, and compositions comprising NBs in combination with electrolyzed water, for example to increase binding of such compositions to bacteria and/or biofilms. The active agents can include, but are not limited to:
antibodies such as monoclonal antibodies, multispecific antibodies, human antibodies, humanized antibodies, camelised antibodies, chimeric antibodies, single-chain Fvs (scFv), single chain antibodies, Fab fragments, F(ab′) fragments, disulfide-linked Fvs (sdFv), and anti-idiotypic (anti-Id) antibodies (e.g., anti-Id antibodies to antibodies of the disclosure), and epitope-binding fragments of any of the above;
immunoglobulin molecules and immunologically active fragments of immunoglobulin molecules (i.e., molecules that contain an antigen binding site) which could be any type, such as IgG, IgE, IgM, IgD, IgA and IgY, class such as IgG1, IgG2, IgG3, IgG4, IgA1 and IgA2 or subclass;
peptides, polypeptides, carbohydrates, hormones, steroids, polysaccharides, lipids, lipopolysaccharides, glycoproteins, lipoproteins, nucleoproteins, oligonucleotides, and nucleic acids, phage (origins include but are not limited to all members of Siphoviridae and Myoviridae);
nanoparticles such as nanoparticles comprising silver, gold, silicon, palladium, titanium, iron, cobalt, copper, zinc, their oxides, nitrides, oxynitrides, carbides, and/or the combinations thereof. The nanoparticles may also be tetrahedra, rods, prisms, cubes, stars, and mainly for magnetic separation in core-shell particles, or core shell particles. The magnetic nanoparticles can comprise but are not limited to ferromagnetic metals and their alloys such as iron-nickel, iron-platinum, cobalt-platinum, their oxides such as, iron oxides (ferric oxides, Magnetite), Ferrites, Oxyhydroxides, Co₃O₄, etc.;
polymers, including but not limited to poly ethylene glycol (PEG), chitosan, Poly diallyl dimethyl amine, Polyvinyl alcohol, Poly (4-vinylpyridine), Poly styrenesulfonate, Poly (maleic acid-co-olefin), Poly dimethylamine, Polyacrylic acid, Polyacrylamide, Poly aspartic acid, Diphosphate, poly ethylenimine, Oleic acid, Dextran-sulfate, Phosphate-starch, lipids, Carboxy methyl dextran); and/or
DNA, RNA, short single chain DNA, and/or aptamers.

Included in embodiments of the invention is Aspect 1, which encompasses a method comprising exposing a substrate to a composition comprising gas bubbles at a concentration and for a length of time sufficient to reduce, interfere with, alleviate, remove, and/or prevent growth and/or presence of one or microbe(s) or biofilm on the substrate.

Aspect 2 is the method of Aspect 1, wherein the exposing is performed relative to a surface of the substrate, or a portion thereof.

Aspect 3 is the method of Aspect 1 or 2, wherein the gas bubbles comprise nanobubbles, nanogas and/or ultrafine bubbles.

Aspect 4 is the method of any of Aspects 1-3, wherein the gas bubbles, nanobubbles, nanogas and/or ultrafine bubbles comprise one or more gas(es) chosen from oxygen, pure oxygen, carbon dioxide, air, nitrogen, chlorine dioxide, octafluoropropane, and/or sulfur hexafluoride, or combinations thereof.

Aspect 5 is the method of any of Aspects 1-4, comprising applying a mechanical force to the substrate in a manner sufficient to remove all or a portion of the microbe(s) and/or biofilm.

Aspect 6 is the method of any of Aspects 1-5, wherein the substrate is metal, stainless steel, mild steel, copper, copper-nickel, bronze, cast iron, aluminum, titanium, Teflon, plastic, Polypropylene, Polyvinyl chloride (PVC), Polystyrene, Polycarbonate, High Density Polyethylene (HDPE), Low Density Polyethylene (LDPE), Acrylonitrile butadiene styrene (ABS), Polyethylene terephthalate (PET), Polyurethane, nylon, glass, composite, concrete, fiber board, food or food products, animal feed, prepared foods, water for food production/preparation, meat, seafood, shellfish, oysters, clams, cockles, mussels, beef, pork, chicken, lamb, mutton, salmon, fish, produce, fresh produce, fruit, apples, grapes, pears, leafy greens, kale, spinach, lettuce, romaine lettuce, vegetables, juices from fruits and/or vegetables, legumes, rice, green beans, broccoli, carrots, celery, strawberries, blueberries, raspberries, onions, potatoes, wood, or combinations thereof.

Aspect 7 is the method of any of Aspects 1-6, wherein the microbe(s) and/or biofilm comprises one or more gram-positive bacteria.

Aspect 8 is the method of any of Aspects 1-7, wherein the microbe(s) and/or biofilm comprises one or more gram-negative bacteria.

Aspect 9 is the method of any of Aspects 1-8, wherein the microbe(s) and/or biofilm comprises one or more single cell organism(s), algae, bacteria, yeast, mold, and/or virus, or one or more of L. innocua, E. coli, A. hydrophila, V. parahaemolyticus bacteria, Campylobacter, Clostridium perfringens, Listeria, Listeria monocytogenes, noroviruses, human norovirus, rotaviruses, sapoviruses, adenoviruses, enteroviruses, astroviruses, Salmonella, Salmonella typhi (Typhoid), Bacillus cereus, Clostridium botulinum (Botulism), Hepatitis A, Hepatitis E, Shigella, Staphylococcus aureus, Toxoplasma, Vibrio Species Causing Vibriosis, Vibrio cholerae (Cholera), Vibrio parahaemolyticus, Vibrio vulnificus, Coronavirus, SARS, COVID, COVID-19, MERS, Nipah virus, Highly Pathogenic Avian Influenza (HPAI) virus, bovine spongiform encephalitis (BSE), Trichinosis, Scrapie, Alternaria, Aspergillus, Botrytis, Cladosporium, Fusarium, Geotrichum, Monilia, Manoscus, Mortierella, Mucor, Neurospora, Oidium, Oosproa, Penicillium, Rhizopus and Thamnidium, Aflatoxin, or combinations thereof.

Aspect 10 is the method of any of Aspects 1-9, wherein the nanobubbles/nanogas and/or ultrafine bubbles are provided in the form of a solution, which comprises one or more sanitizers.

Aspect 11 is the method of any of Aspects 1-10, wherein the sanitizer is electrolyzed water.

Aspect 12 is the method of any of Aspects 1-11, wherein the sanitizer is electrolyzed water with a pH in the range of about 3-7.

Aspect 13 is the method of any of Aspects 1-12, wherein the sanitizer is electrolyzed water with a neutral pH.

Aspect 14 is the method of any of Aspects 1-13, wherein the sanitizer is electrolyzed water with an acidic pH.

Aspect 15 is the method of any of Aspects 1-14, wherein the composition comprises chlorine.

Aspect 16 is the method of any of Aspects 1-15, wherein the chlorine is in the form of hypochlorous acid or free chlorine.

Aspect 17 is the method of any of Aspects 1-16, wherein the chlorine is present in the range of up to about 500 ppm of the composition.

Aspect 18 is the method of any of Aspects 1-17, wherein the hypochlorous acid is present in the range of 100-300 ppm of the composition.

Aspect 19 is the method of any of Aspects 1-18, wherein the hypochlorous acid is present in the range of 150-350 ppm of the composition.

Aspect 20 is the method of any of Aspects 1-19, wherein the hypochlorous acid is present in the range of 200-250 ppm of the composition.

Aspect 21 is the method of any of Aspects 1-20, wherein the hypochlorous acid is present in the range of 275 ppm of the composition.

Aspect 22 is the method of any of Aspects 1-21, wherein the free chlorine is present in the range of up to about 50 ppm of the composition.

Aspect 23 is the method of any of Aspects 1-22, wherein the free chlorine is present in the range of 5-40 ppm of the composition.

Aspect 24 is the method of any of Aspects 1-23, wherein the free chlorine is present in the range of 10-30 ppm of the composition.

Aspect 25 is the method of any of Aspects 1-24, wherein the free chlorine is present in an amount of about 10 ppm of the composition.

Aspect 26 is the method of any of Aspects 1-25, wherein the substrate, surface, or portion thereof is hydrophilic.

Aspect 27 is the method of any of Aspects 1-26, wherein the substrate, surface, or portion thereof is hydrophobic.

Aspect 28 encompasses a method comprising exposing a substrate, a surface of a substrate, or a portion thereof, to a composition comprising gas bubbles of oxygen, pure oxygen, carbon dioxide, air, nitrogen, chlorine dioxide, octafluoropropane, and/or sulfur hexafluoride, or combinations thereof, wherein the exposing is performed before, during or after exposure of the substrate, surface, or portion thereof to one or more single cell organism(s), algae, bacteria, yeast, mold, and/or virus(es), and allowing the exposing to occur for a period of time sufficient for reducing, interfering with, alleviating, removing, and/or preventing adhesion of the single cell organism(s), algae, bacteria, yeast, mold, and/or virus(es) to the substrate, surface of the substrate, or portion thereof.

Aspect 29 is the method of Aspect 28, wherein the gas bubbles comprise nanobubbles, nanogas and/or ultrafine bubbles.

Aspect 30 is the method of Aspect 28 or 29, wherein the exposing is performed for a period of time.

Aspect 31 is the method of any of Aspects 28-30, wherein the exposing is performed for a period of time on the order of minutes.

Aspect 32 is the method of any of Aspects 28-31, wherein the substrate, the surface of the substrate or portion thereof is metal, stainless steel, mild steel, copper, copper-nickel, bronze, cast iron, aluminum, titanium, Teflon, plastic, Polypropylene, Polyvinyl chloride (PVC), Polystyrene, Polycarbonate, High Density Polyethylene (HDPE), Low Density Polyethylene (LDPE), Acrylonitrile butadiene styrene (ABS), Polyethylene terephthalate (PET), Polyurethane, nylon, glass, composite, concrete, fiber board, food or food products, animal feed, prepared foods, water for food production/preparation, meat, seafood, shellfish, oysters, clams, cockles, mussels, beef, pork, chicken, lamb, mutton, salmon, fish, produce, fresh produce, fruit, apples, grapes, pears, leafy greens, kale, spinach, lettuce, romaine lettuce, vegetables, juices from fruits and/or vegetables, legumes, rice, green beans, broccoli, carrots, celery, strawberries, blueberries, raspberries, onions, potatoes, wood, or combinations thereof.

Aspect 33 is the method of any of Aspects 28-32, wherein the bacteria are chosen from gram-positive bacteria, gram-negative bacteria, L. innocua, E. coli, or V. parahaemolyticus or combinations thereof.

Aspect 34 is the method of any of Aspects 28-33, wherein the composition comprises one or more sanitizers.

Aspect 35 is the method of any of Aspects 28-34, wherein the composition comprises electrolyzed water.

Aspect 36 is the method of any of Aspects 28-35, wherein the composition comprises electrolyzed water with a pH in the range of about 5-6.5.

Aspect 37 the method of any of Aspects 28-36, wherein the electrolyzed water has a neutral pH.

Aspect 38 the method of any of Aspects 28-37, wherein the electrolyzed water has an acidic pH.

Aspect 39 is the method of any of Aspects 28-38, wherein the composition comprises chlorine.

Aspect 40 is the method of any of Aspects 28-39, wherein the composition comprises chlorine in the form of hypochlorous acid.

Aspect 41 is the method of any of Aspects 28-40, wherein the composition comprises chlorine in the form of hypochlorous acid present in an amount up to about 500 ppm of the composition.

Aspect 42 is the method of any of Aspects 28-41, wherein the composition comprises chlorine in the form of hypochlorous acid present in an amount ranging from 100-300 ppm of the composition.

Aspect 43 is the method of any of Aspects 28-42, wherein the composition comprises chlorine in the form of hypochlorous acid present in an amount ranging from 150-350 ppm of the composition.

Aspect 44 is the method of any of Aspects 28-43, wherein the composition comprises chlorine in the form of hypochlorous acid present in an amount ranging from 200-250 ppm of the composition.

Aspect 45 the method of any of Aspects 28-44, wherein the composition comprises chlorine in the form of hypochlorous acid present in an amount of about 275 ppm of the composition.

Aspect 46 is the method of any of Aspects 28-45, wherein the composition comprises chlorine in the form of free chlorine.

Aspect 47 is the method of any of Aspects 28-46, wherein the composition comprises chlorine in the form of free chlorine present in an amount of up to about 50 ppm of the composition.

Aspect 48 is the method of any of Aspects 28-47, wherein the composition comprises chlorine in the form of free chlorine present in an amount ranging from 5-40 ppm of the composition.

Aspect 49 is the method of any of Aspects 28-48, wherein the composition comprises chlorine in the form of free chlorine present in an amount ranging from 10-30 ppm of the composition.

Aspect 50 is the method of any of Aspects 28-49, wherein the composition comprises chlorine in the form of free chlorine present in an amount of about 10 ppm, 15 ppm, or 20 ppm of the composition.

Aspect 51 is the method of any of Aspects 28-50, wherein the single cell organism(s), algae, bacteria, yeast, mold, and/or virus comprises one or more of L. innocua, E. coli, A. hydrophila, V. parahaemolyticus bacteria, Campylobacter, Clostridium perfringens, Listeria, Listeria monocytogenes, noroviruses, human norovirus, rotaviruses, sapoviruses, adenoviruses, enteroviruses, astroviruses, Salmonella, Salmonella typhi (Typhoid), Bacillus cereus, Clostridium botulinum (Botulism), Hepatitis A, Hepatitis E, Shigella, Staphylococcus aureus, Toxoplasma, Vibrio Species Causing Vibriosis, Vibrio cholerae (Cholera), Vibrio parahaemolyticus, Vibrio vulnificus, Coronavirus, SARS, COVID, COVID-19, MERS, Nipah virus, Highly Pathogenic Avian Influenza (HPAI) virus, bovine spongiform encephalitis (BSE), Trichinosis, Scrapie, Alternaria, Aspergillus, Botrytis, Cladosporium, Fusarium, Geotrichum, Monilia, Manoscus, Mortierella, Mucor, Neurospora, Oidium, Oosproa, Penicillium, Rhizopus and Thamnidium, Aflatoxin, or combinations thereof.

Aspect 52 encompasses a method for bacterial reduction comprising exposing one or more bacteria or microbe(s) and/or a substrate to a composition or solution comprising gas bubbles.

Aspect 53 is the method of Aspect 52, wherein the gas bubbles comprise nanobubbles, nanogas and/or ultrafine bubbles.

Aspect 54 is the method of Aspect 52 or 53, wherein the bacteria or microbe(s) are provided in the form of a cell-suspension, liquid, or biofilm, or are provided on the substrate, or combinations thereof.

Aspect 55 is the method of any of Aspects 52-54, wherein the substrate is metal, stainless steel, mild steel, copper, copper-nickel, bronze, cast iron, aluminum, titanium, Teflon, plastic, Polypropylene, Polyvinyl chloride (PVC), Polystyrene, Polycarbonate, High Density Polyethylene (HDPE), Low Density Polyethylene (LDPE), Acrylonitrile butadiene styrene (ABS), Polyethylene terephthalate (PET), Polyurethane, nylon, glass, composite, concrete, fiber board, food or food products, animal feed, prepared foods, water for food production/preparation, meat, seafood, shellfish, oysters, clams, cockles, mussels, beef, pork, chicken, lamb, mutton, salmon, fish, produce, fresh produce, fruit, apples, grapes, pears, leafy greens, kale, spinach, lettuce, romaine lettuce, vegetables, juices from fruits and/or vegetables, legumes, rice, green beans, broccoli, carrots, celery, strawberries, blueberries, raspberries, onions, potatoes, wood, or combinations thereof.

Aspect 56 is the method of any of Aspects 52-55, wherein the one or more bacteria or microbe(s) comprise L. innocua, E. coli, A. hydrophila, V. parahaemolyticus bacteria, Campylobacter, Clostridium perfringens, Listeria, Listeria monocytogenes, noroviruses, human norovirus, rotaviruses, sapoviruses, adenoviruses, enteroviruses, astroviruses, Salmonella, Salmonella typhi (Typhoid), Bacillus cereus, Clostridium botulinum (Botulism), Hepatitis A, Hepatitis E, Shigella, Staphylococcus aureus, Toxoplasma, Vibrio Species Causing Vibriosis, Vibrio cholerae (Cholera), Vibrio parahaemolyticus, Vibrio vulnificus, Coronavirus, SARS, COVID, COVID-19, MERS, Nipah virus, Highly Pathogenic Avian Influenza (HPAI) virus, bovine spongiform encephalitis (BSE), Trichinosis, Scrapie, Alternaria, Aspergillus, Botrytis, Cladosporium, Fusarium, Geotrichum, Monilia, Manoscus, Mortierella, Mucor, Neurospora, Oidium, Oosproa, Penicillium, Rhizopus and Thamnidium, Aflatoxin, or combinations thereof.

Aspect 57 is the method of any of Aspects 52-56, wherein the nanobubble/nanogas and/or ultrafine bubbles composition or solution is prepared from water and a gas.

Aspect 58 is the method of any of Aspects 52-57, wherein the nanobubble/nanogas and/or ultrafine bubbles composition of solution comprises one or more gas(es) or gas bubbles comprising air, oxygen, pure oxygen, carbon dioxide, nitrogen, chlorine dioxide, octafluoropropane, sulfur hexafluoride, or a combination of these gases.

Aspect 59 is the method of any of Aspects 52-58, wherein the composition or solution further comprises one or more of chlorine, sodium hypochlorite, peracetic acid (PAA), quaternary ammonium compounds (QUATS), hydrogen peroxide, electrolyzed water (such as EW, AEW and/or NEW), imidazole, pesticides, fungicides, herbicides, and/or surfactants, wherein for example NEW and/or chlorine can be present in an amount ranging from 2 ppm to 200 ppm, QUATS in an amount of up to 200 ppm, PAA in an amount of up to 80 ppm, and ozone in an amount of up to 100 ppm.

Aspect 60 is the method of any of Aspects 52-59, further comprising engineering the nanobubble/nanogas and/or ultrafine bubbles composition or solution by surface modification.

Aspect 61 is the method of any of Aspects 52-60, wherein the surface modification introduces one or more antimicrobial compounds chosen from polymers, phages, peptides, carbohydrates, lipids, fatty acids, alcohols, and/or ketones, or combinations thereof, to the nanobubble solution.

Aspect 62 is the method of any of Aspects 52-61, further comprising introducing a stabilizing agent to the nanobubble/nanogas and/or ultrafine bubbles composition or solution.

Aspect 63 is the method of any of Aspects 52-62, wherein the stabilizing agent comprises one or more antibodies, monoclonal antibodies, multispecific antibodies, human antibodies, humanized antibodies, camelised antibodies, chimeric antibodies, single-chain Fvs (scFv), single chain antibodies, Fab fragments, F(ab′) fragments, disulfide-linked Fvs (sdFv), anti-idiotypic (anti-Id) antibodies, epitope-binding fragments of antibodies, immunoglobulin molecules, immunologically active fragments of immunoglobulin molecules, molecules that contain an antigen binding site, IgG, IgE, IgM, IgD, IgA, IgY, IgG1, IgG2, IgG3, IgG4, IgA1, IgA2, one or more peptides, polypeptides, carbohydrates, hormones, steroids, polysaccharides, lipids, lipopolysaccharides, glycoproteins, lipoproteins, nucleoproteins, oligonucleotides, nucleic acids, phage, one or more members of Siphoviridae and/or Myoviridae, nanoparticles, or combinations thereof.

Aspect 64 is the method of any of Aspects 52-63, wherein the nanoparticles comprise silver, gold, silicon, palladium, titanium, iron, cobalt, copper, zinc, their oxides, nitrides, oxynitrides, or carbides, or combinations thereof.

Aspect 65 is the method of any of Aspects 52-64, wherein the nanoparticles are tetrahedra, rods, prisms, cubes, stars, or core shell particles, or combinations thereof.

Aspect 66 is the method of any of Aspects 52-65, wherein the nanoparticles comprise ferromagnetic metals, metal alloys, iron-nickel, iron-platinum, cobalt-platinum, metal oxide, iron oxides, ferric oxides, Magnetite, Ferrites, Oxyhydroxides, CO₃O₄, polymers, poly ethylene glycol (PEG), chitosan, Poly diallyl dimethyl amine, Polyvinyl alcohol, Poly (4-vinylpyridine), Poly styrenesulfonate, Poly (maleic acid-co-olefin), Poly dimethylamine, Polyacrylic acid, Polyacrylamide, Poly aspartic acid, Diphosphate, poly ethylenimine, Oleic acid, Dextran-sulfate, Phosphate-starch, lipids, Carboxy methyl dextran, DNA, RNA, short single chain DNA, aptamers, or combinations thereof.

### Example 1: Antimicrobial and Antibiofilm Properties of Nanobubbles

The present inventors have invented a novel method for reducing, removing, and/or interfering with adhesion and/or growth of microbe(s) and biofilm(s), for example, on a substrate. The inventors believe they are the first to harness the antibiofilm properties of NB for such applications, and investigate the antibiofilm properties of NB alone and in combination with a sanitizer, such as electrolyzed water (EW) against different biofilm models including gram-negative bacteria (e.g., E. coli O157:H7, and V. parahaemolyticus), and gram-positive bacteria (e.g., L. innocua) on plastic and SS coupons with and without mechanical force.

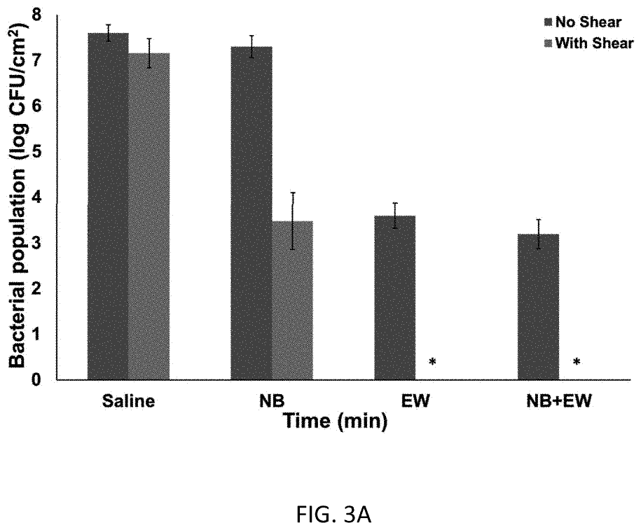

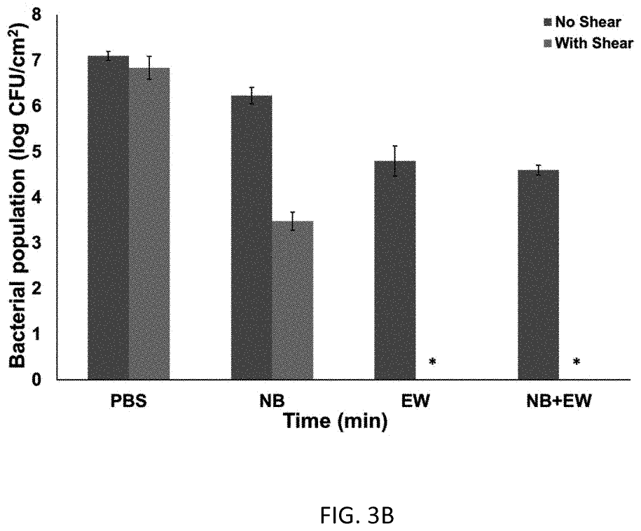

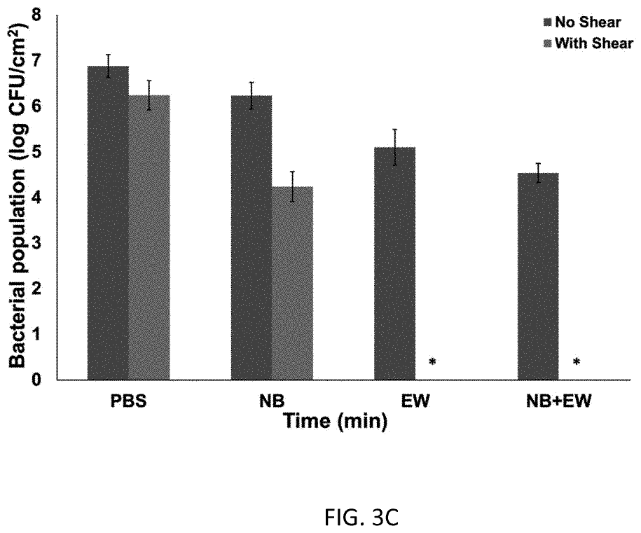

To evaluate the antibiofilm properties of NB, selected microorganisms including E. coli, L. innocua, and V. parahaemolyticus were used to develop biofilms on plastic and SS coupons (FIGS. 3A-C). Samples were treated with PBS or saline solutions as controls, NB, EW, and EWNB solutions at different times with and without shear force. Mechanical shear force increased bacterial removal in samples which were treated with EW and EWNB. However, no bacterial reduction was observed in samples with no mechanical force after treating with NB solution. Under no mechanical shear stress condition, 4, 2.3 and 1.8 CFU/cm² reduction by EW was observed on V. parahaemolyticus, E. coli and L. innocua biofilms, respectively. While, complete inactivation was observed after applying mechanical force.

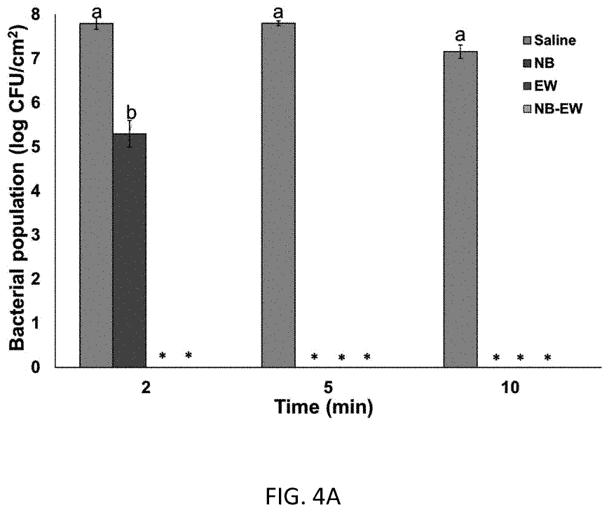

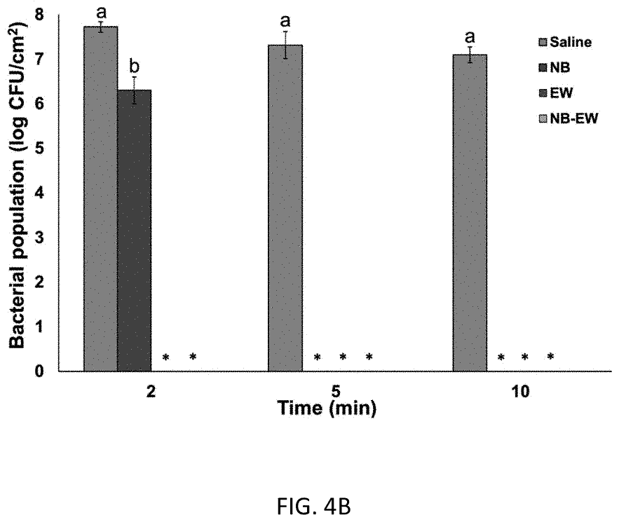

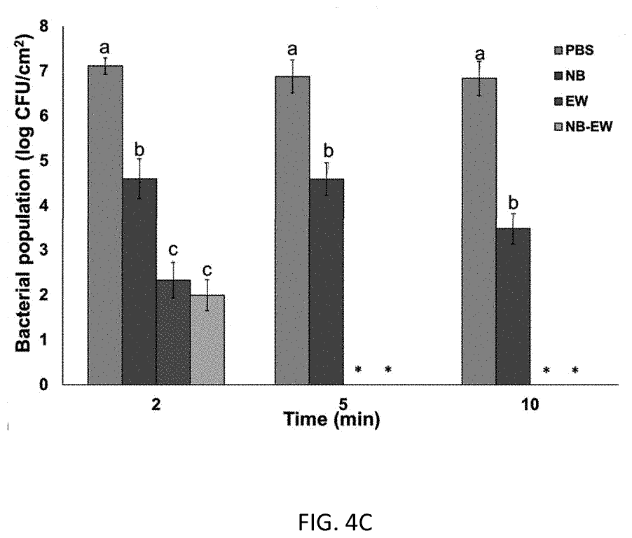

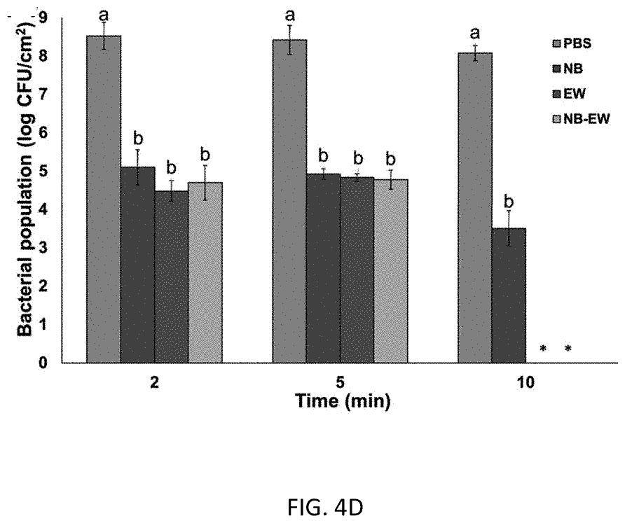

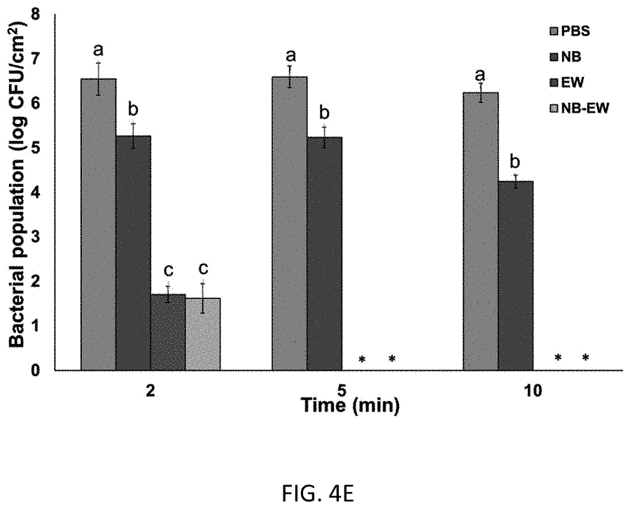

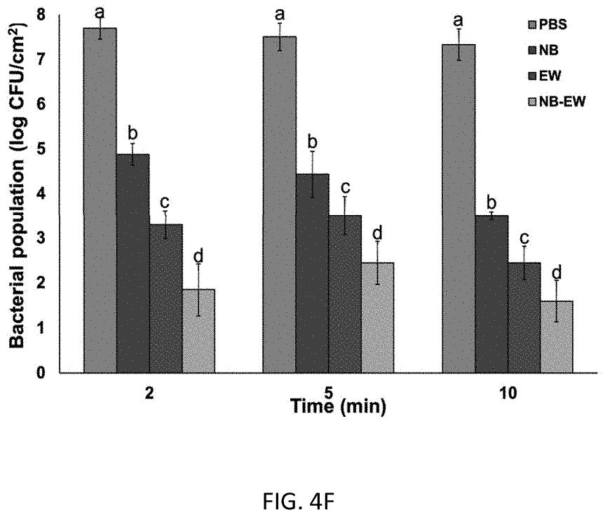

FIGS. 4A-B illustrate the influence of test solutions on different bacterial biofilms at different exposure times. FIG. 4A and FIG. 4B show V. parahaemolyticus biofilms responses to different solutions on plastic and SS coupons, respectively. The results of antibiofilm properties of different solutions on E. coli and L. innocua are presented in FIGS. 4C-D and FIGS. 4E-F, respectively. The results showed that V. parahaemolyticus biofilm was the most sensitive biofilm to solutions, and L. innocua biofilm was the most resistant biofilm to tested solutions.

V. parahaemolyticus results showed 1.4 and 2.5 log CFU/cm² reduction after 2 min. exposure to NB solution on SS and plastic coupons, respectively. Complete V. parahaemolyticus biofilm removal was achieved within 5 min. after exposure to NB with more than 7 log CFU/cm² reduction.

NB induced 3.4, 3.5 and 4.6 log CFU/cm² reduction in E. coli biofilms on SS coupons, after 2, 5, and 10 min. treatment, respectively, while on plastic coupons, 2.5, 2.3 and 3.4 log CFU/cm² reduction was observed after 2, 5 and 10 min. of exposing E. coli biofilm to NB, respectively.

L. innocua biofilm was more resistant to the treatments compared to the other tested bacterial biofilms. On plastic coupons, 1.3, 1.35, and 2 log CFU/cm² reduction was observed after the biofilms treated with NB for 2, 5 and 10 min., respectively, while reductions of L. innocua on SS coupons treated with NB was 2.8, 3.1 and 3.8 log CFU/cm² after 2, 5 and 10 min., respectively.

In the presence of hypochlorous acid (EW and EWNB), the rate of reduction was increased and more than 7 log CFU/cm² reduction of V. parahaemolyticus was achieved after 2 min. on biofilms. In the presence of EW, more than 8 log CFU/cm² reduction of E. coli was observed after 5 and 10 min., on plastic and SS coupons, respectively.

L. innocua biofilms on plastic coupons were completely removed in the presence of EW (more than 6 log CFU/cm²). Although, more reduction was observed on SS coupons in the presence of EW, complete inactivation was not achieved.

These results are consistent with other researchers' findings, which showed that V. parahaemolyticus and E. coli O157:H7 were more sensitive to EW compared to L. monocytogenes due to differences in the cell wall structure of Gram-negative and Gram-positive bacteria and the thicker and more rigid cell envelopes in Gram positive bacteria which can protect them from sanitizers (see Ovissipour et al., 2015; Venkitanarayanan, K. S., Ezeike, G. O., Hung, Y. C. & Doyle, M. P. Efficacy of electrolyzed oxidizing water for inactivating Escherichia coli O157:H7, Salmonella enteritidis, and Listeria monocytogenes. Appl. Environ. Micro. 65(9), 4276-4279 (1999); Kim, C., Hung, Y. C. & Brackett, R. E. Efficacy of electrolyzed oxidizing (EO) and chemically modified water on different types of foodborne pathogens. Int. J. Food Micro. 61(2-3), 199-207 (2000); Park, H., Hung, Y. C. & Chung, D. Effects of chlorine and pH on efficacy of electrolyzed water for inactivating Escherichia coli O157:H7 and Listeria monocytogenes. Int. J. Food Micro. 91(1), 13-18 (2004); Guentzel, J. L., Lam, K. L., Callan, M. A., Emmons, S. A. & Dunham, V. L. Reduction of bacteria on spinach, lettuce, and surfaces in food service areas using neutral electrolyzed oxidizing water. Food Micro. 25(1), 36-41 (2008)).

The results illustrate that exposure time and mechanical force had a significant role in reducing the bacterial biofilms from plastic and SS coupons. Similar results were reported by prior studies on bacterial detachment from different surfaces. Huang et al. (2018) showed that exposure time and mechanical force (shear force) had a significant role in bacterial reduction from fresh produce surfaces. They reported that the bacterial reduction was significantly enhanced by increasing the shear force from 0 to 200 rpm (see Huang, K., Tian, Y., Salvi, D., Karwe, M. & Nitin, N. Influence of exposure time, shear stress, and surfactants on detachment of Escherichia coli 0157: H7 from fresh lettuce leaf surfaces during washing process. Food Biopro. Tech. 11(3), 621-633 (2018)). Ushida et al. (2017) found that mechanical forces including fluid flow, shear and friction, have a significant role in enhancing the bacterial detachment by NB. Similar to our findings, other researchers also reported the importance of applying mechanical force and exposure time for removing bacteria, biofilm and organic loads using NB (see Hayakumo et al., 2014; Ushida et al., 2017; Burfoot, D., Limburn, R. & Busby, R. Assessing the effects of incorporating bubbles into the water used for cleaning operations relevant to the food industry. Int. J. Food Sci. Tech. 52(8), 1894-1903 (2017)).

The results also show that the antibiofilm properties of EW and NB alone, were enhanced after mixing the solutions as EWNB treatment which agreed with other researchers' findings (see Ushida et al., 2017). It has been pointed out that combining NB with chemicals including chlorine or electrolyzed water at sub-lethal levels, would increase the antimicrobial efficacy of the combinations (see Burfoot et al., 2017). The bactericidal properties of nanobubbles are similar to those of ozonated water, which is an oxidizing agent. Thus, free radical-mediated oxidation reactions play an important role in removing the biofilms by NB (see Hayakumo et al., 2014). NB in the water can reduce the surface tension due to the cluster cleavage of the hydrogen bonds among water molecules and ionization of any chemicals in the water, and also due to the excess of hydroxyl ions (OH⁻) at the gas-water interface resulting in negative zeta potential in NB (see Phan et al., 2019). The results of the contact angle of the plastics and SS treated with NB showed that NB reduced the contact angle from 79° in untreated plastic to 76.8° in NB-treated plastic, and from 70.1 in untreated SS to 67.3 in NB treated SS, illustrating that the decrease in surface contact angles, improves the removal of bacteria which agrees with other researchers' findings (see Huang, K. & Nitin, N. Enhanced removal of Escherichia coli 0157: H7 and Listeria innocua from fresh lettuce leaves using surfactants during simulated washing. Food Control 79, 207-217 (2017)). The results of this study suggest that NB can be used as a surfactant for reducing surface tension, and enhancing the bacterial removal from surfaces.

Materials and Methods

Bacterial Strain and Inoculum Preparation

Shiga toxin negative E. coli O157:H7 was provided by Dr. Trevor Suslow from the Department of Food Science and Technology at University of California, Davis. E. coli was modified with a Rifampicin (RIF) resistant plasmid and was cultured on tryptic soy agar (Sigma-Aldrich, St. Louis, Mo., USA) with RIF (50 μg ml⁻¹) and grown at 37° C. for 24 h. Bacterial strain of L. innocua (VTE-P1-0002) was obtained from the bacterial culture collection of Dr. Laura Strawn at the Eastern Shore AREC, Virginia Tech and were cultured on PALCAM agar (Merck, Darmstadt, Germany). Bacterial strains of V. parahaemolyticus were isolated from the marine environment using TCBS and Vibrio ChromAgar. Frozen stock cultures of the strains were streaked on agar media and incubated at 37° C. for 24 h, except for V. parahaemolyticus which was incubated at 35° C. for 24 h. A loop of these cultures was transferred two successive times into 10 ml of tryptic soy broth and incubated at 37° C. and 35° C. (V. parahaemolyticus) for 18 hours. An aliquot of 1 ml of the broth culture was pipetted into a 1.5 ml centrifuge tube and centrifuged at 12000 rpm for 2 minutes. Supernatant was discarded and the resultant pellets were resuspended with 1 ml of sterile phosphate buffer saline (PBS), and centrifuged at 12000 rpm for 2 minutes. This process was repeated twice, and the pellet from the second wash was resuspended in 1 ml sterile PBS. The population of bacteria in inoculum was approximately 109 CFU/ml.

Biofilm Preparation

The biofilms were grown on the plastic microscope cover slips slides (Fisherbrand® 22×22 mm, Fisher Scientific, Pittsburgh, Pa., USA) and 304 SS disc coupons (12.7 mm diameter) (Biosurface Technologies Co., Bozeman, Mont.). Prior to use, all SS coupons were sonicated (Branson CPX2800, Fisher brand) in 70% ethanol solution for 10 min., rinsed 3 times with sterile deionized water, then sonicated in 35% nitric acid for 10 min., rinsed 5 times with sterile deionized water, followed by sonication in water for 2 min. The coupons were then autoclaved at 121° C. for 15 min. and dried under the biosafety hood for 30 min.

Sterile plastic slides and SS coupons were separately submerged in 10 ml of 1×M9 medium supplemented with 0.4% glucose and 0.4% tryptone. A 100 μl of inoculum was added and samples were inoculated at 37° C. for 4 hours for bacterial attachment. Coupons were kept at room temperature (22±2° C.) for 3 days for the biofilm growth except for E. coli which was kept for 4 days.

Test Solutions and Mechanical Shear Force

Commercially-available NEW (Aquaox Disinfectant 275) was provided from Aquaox LLC. (Dillsburg, Pa., USA) with active hypochlorous acid (275 ppm) generated electrochemically by electrolysis of a diluted sodium chloride solution passing through an electrolytic cell at neutral pH. The NB solution was provided using deionized water and pure oxygen gas by Moleaer 25L nanobubble generator (Moleaer Inc., Torrance, Calif.). Preliminary experiments showed that NB produced by pure oxygen showed stronger antibiofilm properties as compared to NB generated by pure carbon dioxide or air.

EW containing 10 ppm free chlorine concentration, NB water (Dissolved oxygen=40 mg1⁻¹), and a combination of NB and EW (10 ppm free chlorine concentration) were used to compare the efficacy of these solutions to inactivate bacterial biofilms (E. coli, L. innocua, and V. parahaemolyticus) on plastic and SS coupons. The free chlorine concentration of sample solutions containing chlorine was determined with a DPD assay (Colorimeter™ Analysis System, Hach Co., Loveland, Colo., USA) according to manufacturer instructions. Dissolved oxygen of NB water was measured with a DO meter (YSI-Pro2030; YSI Incorporated, Yellow Springs, Ohio, USA). To analyze the effect of shear stress on the removal of bacterial biofilms from plastic and SS surfaces, samples including control groups were exposed to 200 rpm shear force according to Huang et al. (2018), to create turbulent flow. The pH of final solutions was between 6.5 to 7.

Antimicrobial Activity of Test Solutions and Bacterial Recovery

The coupons with biofilms were washed gently with PBS before treating with experimental solutions to remove any loose bacteria. At specific time points (2, 5, and 10 min.) 1 ml sterile 2% sodium thiosulphate solution (pH=5.45) was added to the solution to neutralize chlorine and stop the reaction. Sodium thiosulphate solution also was added to the control groups (PBS and saline solution). For enumeration of bacterial population, the plastic cover slips and SS coupons were placed into 50-mL falcon tubes containing 10 ml sterile maximum recovery diluent (MRD; Oxoid, Basingstoke, UK), vortexed vigorously for 1 min. and sonicated for 2 min. in an ultrasound bath (Branson CPX2800, Fisher brand) at room temperature. Serially diluted solutions were cultured on TSAR (tryptic soy agar supplemented with rifampicin (50 μg ml-1)), PALCAM agar, and TCBS for E. coli, L. innocua, and V. parahaemolyticus, respectively. Then plates were incubated at 37° C. for 24 h and 48 h for E. coli and L. innocua, respectively, and 35° C. for 24 h for V. parahaemolyticus.

Raman Spectroscopy

L. innocua biofilm was selected as a bacterial biofilm model for further analysis using a Raman confocal microscope due to the fact thatL. innocua was the most resistant bacteria among studied microorganisms to the tested solutions, which could potentially provide a clear trend in biofilm structural changes. L. innocua biofilms were not removed completely from SS using different solutions (FIGS. 4A-F). Raman spectra were collected using a DXR2 microscopy Raman spectrometer (Thermo Fisher Scientific Inc., Waltham, Mass.) equipped with a 785 nm diode laser source. SERS spectra were collected from biofilms on SS coupons with 30 mW laser power from 1700 to 500 cm⁻¹ with a spectral resolution of 5 cm⁻¹. Each spectrum was the average of three scans with exposure time of 10 seconds per scan. SERS map was created by raster scans of the biofilm in an area of 60 μm×50 μm with 8 points, using automatic-controlled xyz motorized stage and Atlμs mapping software.

Aspect 67 encompasses a substrate treated with nanobubbles/nanogas and/or ultrafine bubbles.

Aspect 68 encompasses a substrate treated with nanobubbles/nanogas and/or ultrafine bubbles according to any method of Aspects 1-67.

Aspect 69 encompasses a substrate resistant to one or more microbe(s) comprising a surface treated with nanobubbles/nanogas and/or ultrafine bubbles.

Aspect 70 is the substrate of any of Aspects 67-69 prepared using any method in whole or part described in any of Aspects 1-69.

Aspect 71 is the substrate of any of Aspects 67-70 prepared using any method in whole or part described in any of Aspects 1-70 and further comprising exposing the substrate to ultrasound.

Aspect 72 encompasses a substrate having a reduced amount of one or more microbe(s) comprising a surface exposed to nanobubbles/nanogas and/or ultrafine bubbles, wherein the reduced amount of microbe(s) is as compared with an untreated substrate.

Aspect 73 is the substrate of any of Aspects 67-72, wherein the substrate is chosen from metal, stainless steel, mild steel, copper, copper-nickel, bronze, cast iron, aluminum, titanium, Teflon, plastic, Polypropylene, Polyvinyl chloride (PVC), Polystyrene, Polycarbonate, High Density Polyethylene (HDPE), Low Density Polyethylene (LDPE), Acrylonitrile butadiene styrene (ABS), Polyethylene terephthalate (PET), Polyurethane, nylon, glass, composite, concrete, fiber board, food or food products, animal feed, prepared foods, water for food production/preparation, meat, seafood, shellfish, oysters, clams, cockles, mussels, beef, pork, chicken, lamb, mutton, salmon, fish, and produce, fresh produce, fruit, apples, grapes, pears, leafy greens, kale, spinach, lettuce, romaine lettuce, vegetables, juices from fruits and/or vegetables, legumes, rice, green beans, broccoli, carrots, celery, strawberries, blueberries, raspberries, onions, potatoes, wood, or combinations thereof.

Aspect 74 is the substrate of Any of Aspects 67-73, wherein the microbe(s) are chosen from single cell organism(s), algae, bacteria, yeast, mold, and/or virus, or comprises one or more of L. innocua, E. coli, A. hydrophila, V. parahaemolyticus bacteria, Campylobacter, Clostridium perfringens, Listeria, Listeria monocytogenes, noroviruses, human norovirus, rotaviruses, sapoviruses, adenoviruses, enteroviruses, astroviruses, Salmonella, Salmonella typhi (Typhoid), Bacillus cereus, Clostridium botulinum (Botulism), Hepatitis A, Hepatitis E, Shigella, Staphylococcus aureus, Toxoplasma, Vibrio Species Causing Vibriosis, Vibrio cholerae (Cholera), Vibrio parahaemolyticus, Vibrio vulnificus, Coronavirus, SARS, COVID, COVID-19, MERS, Nipah virus, Highly Pathogenic Avian Influenza (HPAI) virus, bovine spongiform encephalitis (BSE), Trichinosis, Scrapie, Alternaria, Aspergillus, Botrytis, Cladosporium, Fusarium, Geotrichum, Monilia, Manoscus, Mortierella, Mucor, Neurospora, Oidium, Oosproa, Penicillium, Rhizopus and Thamnidium, Aflatoxin, or combinations thereof.

Aspect 75 is the substrate of any of Aspects 67-74, wherein the nanobubbles/nanogas and/or ultrafine bubbles comprise one or more gas(es) chosen from oxygen, pure oxygen, carbon dioxide, air, nitrogen, chlorine dioxide, octafluoropropane, and/or sulfur hexafluoride, or combinations thereof.

### Example 2: Preventing Bacterial Adhesion

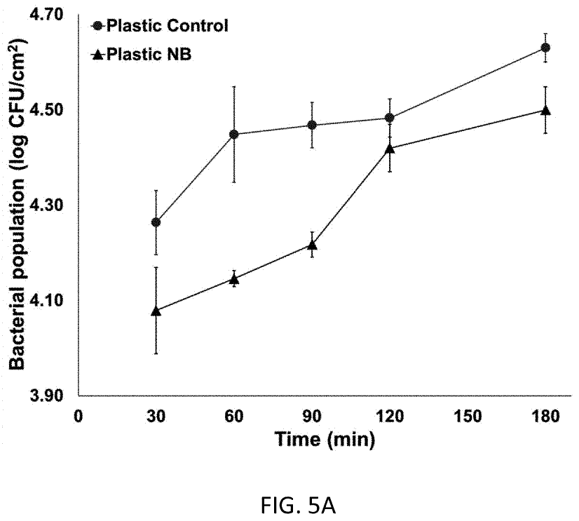

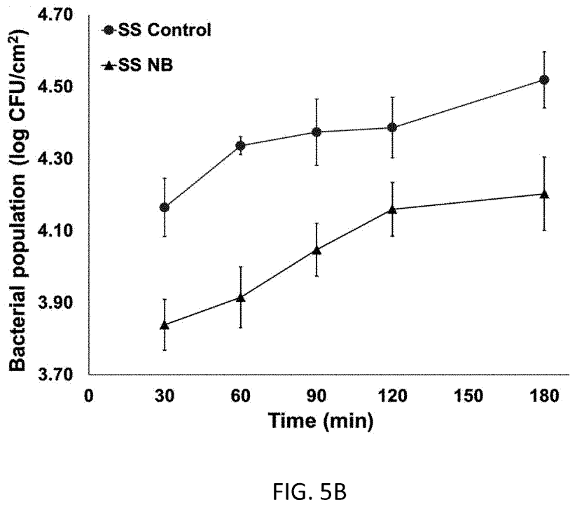

In order to investigate the antiadhesion properties of NB, plastic and SS coupons were immersed into NB solutions for 10 min. prior to exposure to a bacterial solution. Both coupons were placed into PBS containing 10⁶ log CFU/ml of L. innocua for 30, 60, 90, 120, and 180 min. The results illustrate lower bacterial adhesion to NB-treated surfaces compared to the untreated surfaces (FIG. 5A-B). No differences in adhesion kinetics were observed between NB-treated and untreated coupons.

The bacterial populations of NB-treated and untreated plastic coupons after 30 min. were 4.07 and 4.3 log CFU/cm², respectively. On SS coupons, bacterial populations were 3.8 and 4.2 log CFU/cm² on NB-treated and untreated surfaces, respectively.

Materials and Methods

See Example 1 for bacterial strain and inoculum preparation.

Antiadhesion Study

Antiadhesion properties of NB were studied according to Bridgett et al. (1992) (see Bridgett, M. J., Davies, M. C. & Denyer, S. P. Control of staphylococcal adhesion to polystyrene surfaces by polymer surface modification with surfactants. Biomaterials 13(7), 411-416 (1992)). Plastic and SS coupons were treated with NB solution for 10 min. by immersing coupons into the NB solution at room temperature. Untreated coupons were used as the control. Prior to placing the treated coupons into the 6-well polystyrene plates, 5 ml PBS was added to each well, and a 100 ml of previously washed L. innocua was added to obtain 10⁶ CFU/ml as the final concentration of bacteria. Treated coupons were placed into the wells and incubated at 37° C. for 30, 60, 90, 120, and 180 min. Coupons were removed and washed with PBS to remove any loosely attached bacteria, and were placed into a 50-mL falcon tube containing 10 ml MRD. After vortexing for 1 min., bacteria were recovered and cultured on PALCAM agar at 37° C. for 48 hours.

Contact Angle Measurement

Contact angle was measured at room temperature using Theta Optical Tensiometer (Attension, Biolin Scientific, Stockholm, Sweden). Droplet volume of 15 μl of deionized water was dropped on the surfaces and advancing contact angles was recorded and calculated using the sessile drop method (OneAttension version1.8, Biolin Scientific, Stockholm, Sweden).

### Example 3: Biofilm SERS Spectra and Raman Mapping

Raman confocal microscope was applied to gain a better understanding of the chemical signature of the biofilms to investigate the impact of NB, NEW, and combination of NB and NEW (such as EWNB) on the chemical structures of biofilms. In addition, mapping and chemical image analyzing of biofilms on SS coupons were applied.

New vibrational spectroscopic methods have made it possible to study the chemical properties of biofilms at the molecular levels including Fourier transform infrared (FTIR) spectroscopy or Raman spectroscopy with confocal microscopy which can enable researchers to provide detailed chemical information about microbial cells and complex biofilm matrices (see Ovissipour et al., 2018; Lu et al., 2012; Ivleva et al., 2010).

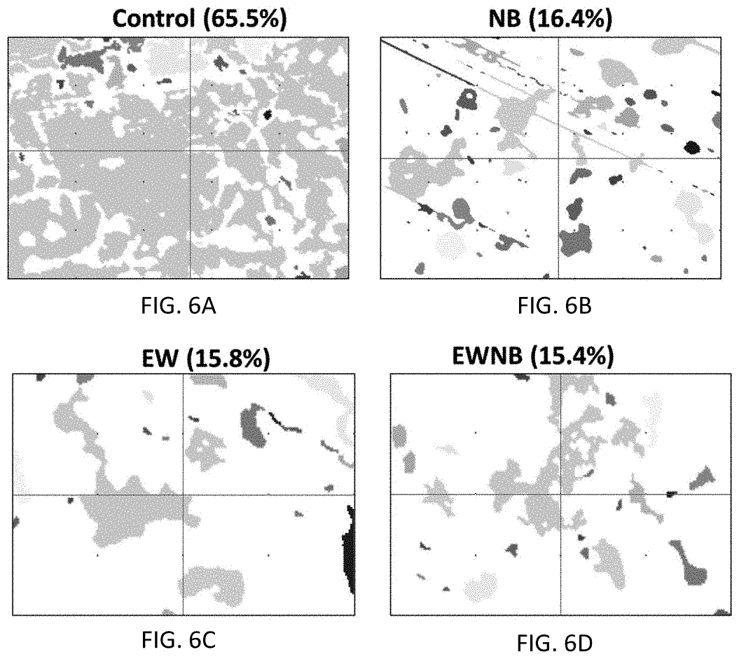

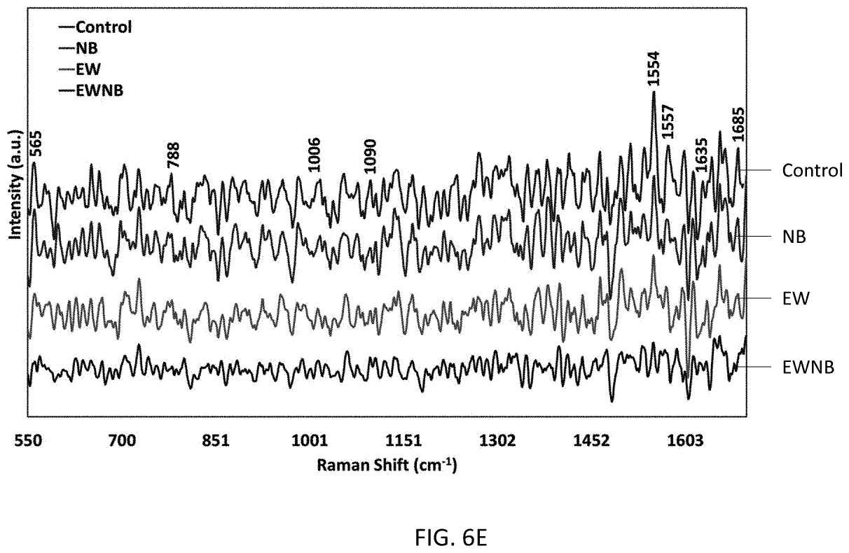

For SERS spectra and Raman mapping, only L. innocua biofilm on SS coupons were used. L. innocua biofilm on SS coupons showed resistance to the disinfectant solutions, making it an appropriate treatment for studying the EPS removal trend using Raman. Furthermore, SS coupons were selected, because unlike plastic coupons, SS does not interfere with EPS spectra. The SERS spectra and chemical composition image of different L. innocua biofilms are presented in FIGS. 6A-E. Several bands including 1685, 1635, 1557, 1554, 1090, 1006, 788, and 565 cm⁻¹, representing Amide I (protein), DNA, Amide II (protein), C—O—C glycosidic link (EPS polysaccharide), phenylalanine (protein), DNA, and C—O—C glycosidic link (EPS deformation polysaccharide) were characterized (see Han et al., 2017; Movasaghi, Z., Rehman, S. & Rehman, I. U. Raman spectroscopy of biological tissues. Appl. Spect. Rev. 42(5), 493-541 (2007); Wang, J. et al. Rapid detection of Listeria monocytogenes in milk using confocal micro-Raman spectroscopy and chemometric analysis. Int. J. Food Micro. 204, 66-74 (2015)). Spectral features associated with polysaccharides, nucleic acids and proteins in the Raman spectra for these biofilms are impacted by antimicrobial treatments. The Raman bands of EPS in L. innocua biofilm at 1090 and 565 cm⁻¹ representing C—O—C glycosidic link, were decreased significantly after exposing to NB, EW and EWNB solutions, indicating the destruction of the carbohydrate structure. Raman intensity was reduced at bands around 1685, 1635, 1554 and 1006 cm⁻¹ representing protein, after exposing to test solutions. The Amid I bands at 1685 and 1635 cm⁻¹ were reduced after treating the biofilms by NB and EW, and disappeared in the EWNB treatment. The band intensity decreased at 1006 cm⁻¹ attributes to the ring deformation of phenylalanine, indicating the denaturation of protein which can cause cell death (see Han et al., 2017), which similar results were reported by prior reports that the protein in EPS was decreased significantly by EW or antibiotics (see Han et al., 2017; Lu, X., Samuelson, D. R., Rasco, B. A. & Konkel, M. E. Antimicrobial effect of diallyl sulphide on Campylobacter jejuni biofilms. J Antimicro. Chemoth. 67(8), 1915-1926 (2012)).

The decrease of Raman intensity at 788 and 1557 which correspond to DNA, indicates DNA degradation due to the strong oxidative properties of NB, EW, and EWNB solutions. Similar trends were observed by other researchers after exposing L. monocytogenes biofilm to acidic EW (see Han et al., 2017); Campylobacter jejuni biofilms treated with antibiotics (see Lu et al., 2012); L. monocytogenes planktonic cells treated with acidic and neutral EW (see Ovissipour et al., 2018), and pure DNA and E. coli after exposing to different concentrations of chlorine (see Ovissipour, R., Rai, R. & Nitin. N. DNA-based surrogate indicator for sanitation verification and predict inactivation of Escherichia coli O157:H7 using vibrational spectroscopy (FTIR). Food Control 100, 67-77 (2019)).

Optical images of biofilms provided by Raman were analyzed based on the map and chemical composition of EPS results from SERS spectra (FIGS. 6A-D). The results revealed that in the control group, 65.5% of the SS coupons were covered by L. innocua biofilm.

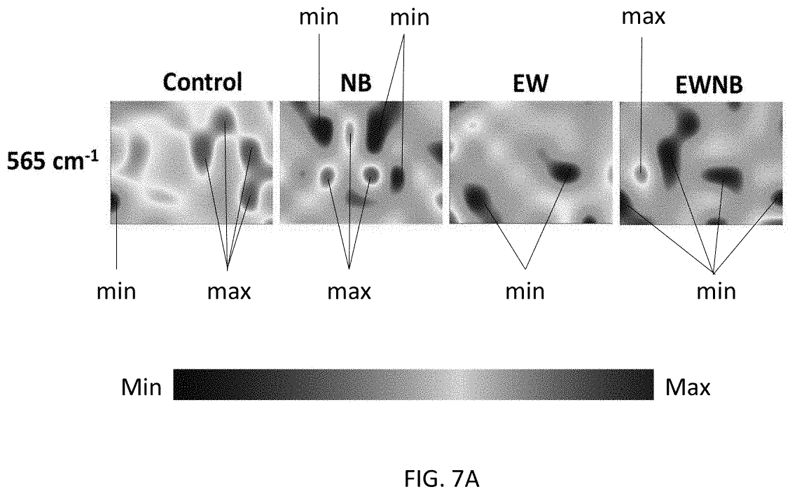

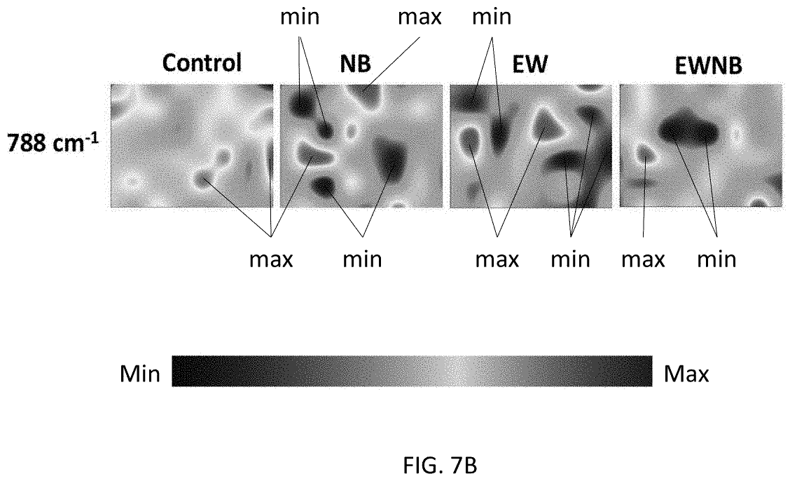

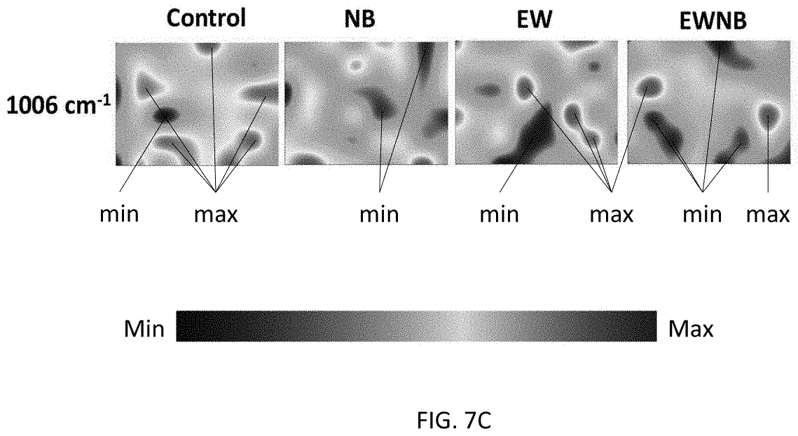

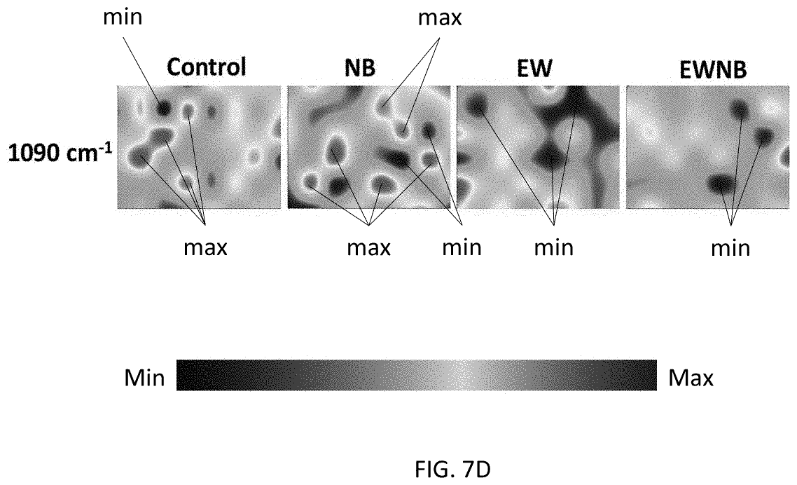

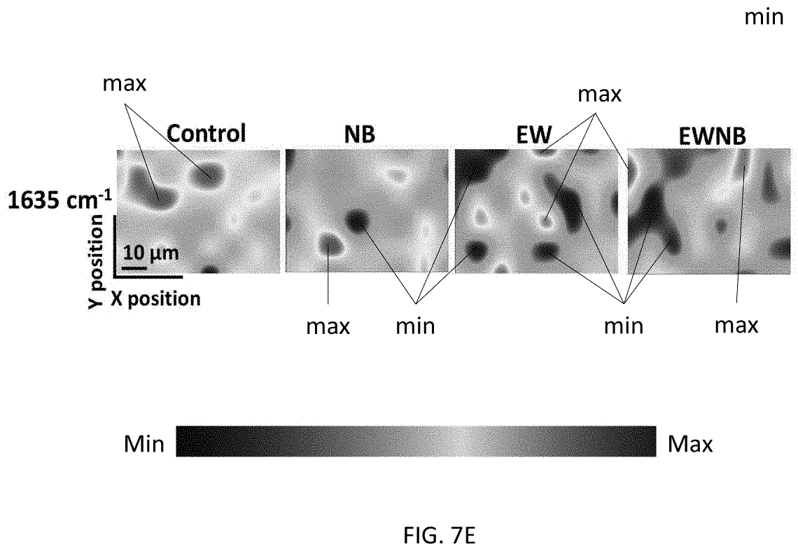

However, after treating the coupons with NB, EW, and EWNB solutions the area was significantly reduced to 16.4%, 15.8%, and 15.4%, respectively, which is in agreement with the Raman mapping results (FIG. 7).

Mechanical insults can result in partial removal of biofilms (see Han et al., 2017). The results showed that without applying mechanical force, no bacterial reduction was observed in NB-treated biofilms, indicating that the flow and shear force can increase the bubbles interactions with EPS resulting is EPS disruption, which is in line with recent observations of the tole of air microbubbles with a mean flow speed of 250 μm s⁻¹ on reducing biofilm coverage by nearly two thirds (see Han et al., 2017).

Raster scanning is a technique for capturing a video rectangular pattern of an image line by line. Raman maps of relevant band intensities were provided and correlated with the regions on the optical images of biofilms. FIG. 7 illustrates the SERS mapping images which were provided for an area of 60 μm×50 μm for the SERS bands at 1635, 1090, 1006, 788, and 565 cm¹, representing Amide I (protein), C—O—C glycosidic link (EPS polysaccharide), phenylalanine (protein), DNA, and C—O—C glycosidic link (EPS deformation polysaccharide), respectively (see Han et al., 2017; Movasaghi et al., 2007; Wang et al., 2015). The results of different bands mapping illustrate the relative abundance of polysaccharides, proteins and nucleic acids within the biofilm in control and treated samples. Based on the intensity of the chemical compounds on the EPS matrix, all bands showed strong intensity in the control group. However, after treating the biofilms using NB, EW, and NBEW, the intensity was reduced, indicating that the biofilm was disrupted by the solutions.

Materials and Methods

See Example 1 for bacterial strain and inoculum preparation.

Raman Study: Preparation of Colloidal Silver Nanoparticles

Silver NP colloid was prepared according to Lee and Meisel (1982) (see Lee, P. C. & Meisel, D. Adsorption and surface-enhanced Raman of dyes on silver and gold sols. J Phys. Chem. 86(17), 3391-3395 (1982)). In particular, 90 mg of AgNO₃ was dissolved in 500 ml of deionized water. The solution was heated and boiled, then a 10 ml aliquot of 1% sodium citrate was added to the solution and kept boiling until the volume reach 250 ml. 20 μl of the silver colloid was added to each SS coupon containing L. innocua biofilm, and samples were dried for 1 hour under the hood. L. innocua was selected for Raman study because it showed higher resistance to the treatments.

Aspect 76 encompasses a method for killing one or more microbe(s) comprising preparing a composition, of gas bubbles comprising pure oxygen, oxygen, carbon dioxide, air, nitrogen, chlorine dioxide, octafluoropropane, and/or sulfur hexafluoride, or combinations thereof, exposing the composition to one or more microbe(s), and exposing the composition and microbe(s) to ultrasound.

Aspect 77 is the method of Aspect 76, wherein the gas bubbles comprise nanobubbles, nanogas and/or ultrafine bubbles.

Aspect 78 is the method of Aspect 76 or 77, wherein the composition is a solution.

Aspect 79 is the method of any of Aspects 76-78, wherein the one or more microbes comprise single cell organism(s), algae, bacteria, yeast, mold, and/or virus, or L. innocua, E. coli, A. hydrophila, V. parahaemolyticus bacteria, Campylobacter, Clostridium perfringens, Listeria, Listeria monocytogenes, noroviruses, human norovirus, rotaviruses, sapoviruses, adenoviruses, enteroviruses, astroviruses, Salmonella, Salmonella typhi (Typhoid), Bacillus cereus, Clostridium botulinum (Botulism), Hepatitis A, Hepatitis E, Shigella, Staphylococcus aureus, Toxoplasma, Vibrio Species Causing Vibriosis, Vibrio cholerae (Cholera), Vibrio parahaemolyticus, Vibrio vulnificus, Coronavirus, SARS, COVID, COVID-19, MERS, Nipah virus, Highly Pathogenic Avian Influenza (HPAI) virus, bovine spongiform encephalitis (BSE), Trichinosis, Scrapie, Alternaria, Aspergillus, Botrytis, Cladosporium, Fusarium, Geotrichum, Monilia, Manoscus, Mortierella, Mucor, Neurospora, Oidium, Oosproa, Penicillium, Rhizopus and Thamnidium, Aflatoxin, or combinations thereof.

Aspect 80 is the method of any of Aspects 76-79, wherein the exposing to ultrasound is performed for an amount of time sufficient to reduce the amount of microbe(s) or bacteria by up to 99.9999%, or up to about 90%, or up to about 99%, or up to about 99.9%, or 95%, or up to 98%.

Aspect 81 is the method of any of Aspects 76-80, wherein the exposing to ultrasound is performed for a time of less than or equal to about 15 minutes.

Aspect 82 is the method of any of Aspects 76-81, wherein the microbe is one or more of gram-positive bacteria, gram-negative bacteria, L. innocua, E. coli, V. parahaemolyticus, A. hydrophila, or combinations thereof.

Aspect 83 is the method of any of Aspects 76-82, wherein the nanobubbles/nanogas and/or ultrafine bubbles are prepared using deionized water and a gas.

### Example 4: Nanobubbles and Ultrasound Inactivation of Bacteria

To the best of the inventors' knowledge, this was the first time that nanobubbles technology was used with ultrasound to inactivate bacteria.

Synergistic antimicrobial activity of nanobubbles and ultrasound was observed against V. parahaemolyticus, and A. hydrophila. The nanobubbles solution was provided using deionized water and pure oxygen gas by Moleaer 25L nanobubble generator (Moleaer Inc., Torrance, Calif.). Preliminary experiments showed that nanobubbles produced by pure oxygen showed stronger antibiofilm and antimicrobial properties as compared to nanobubbles generated by pure carbon dioxide or air. 1 ml of the previously washed bacterial cell suspensions were added to 9 ml of nanobubbles. The solutions were exposed to ultrasound for 5, 10, and 15 min. Bacteria in PBS with ultrasound, and bacteria in nanobubbles without ultrasound were used as control.

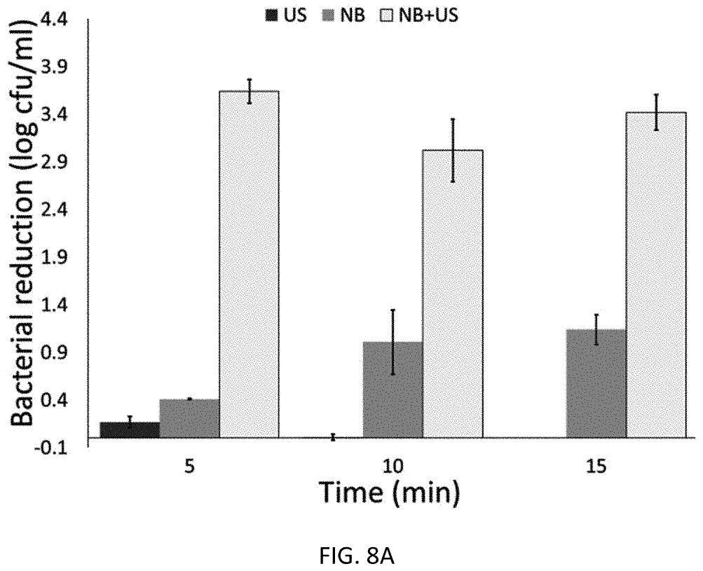

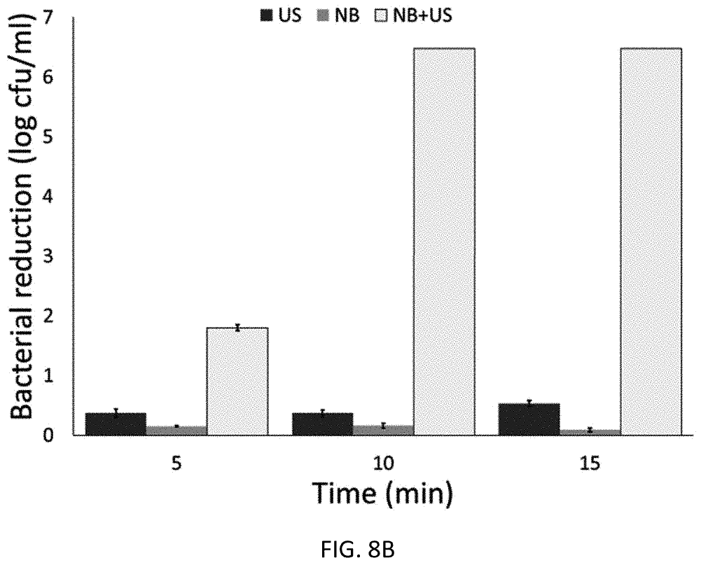

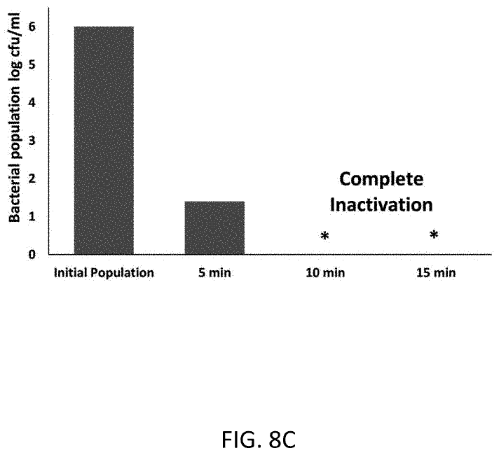

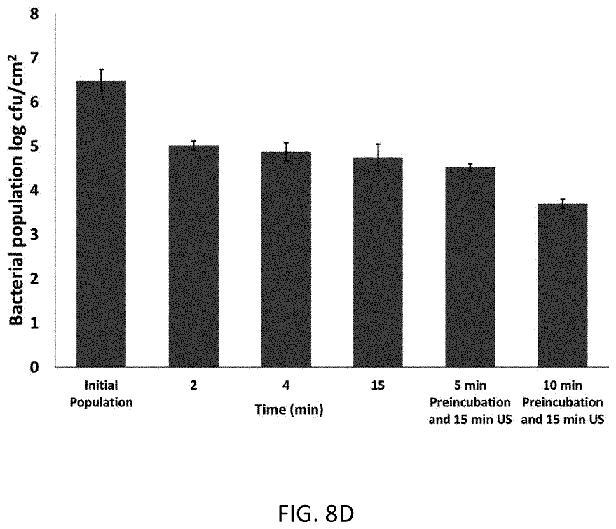

FIGS. 8A-B illustrate bacterial reduction in cell suspensions after exposing to nanobubbles, ultrasound and nanobubbles+ultrasound for 5 to 15 min. The results showed that the combination of nanobubbles and ultrasound induced more than 3 and 6 log cfu/ml reduction of V. parahaemolyticus and A. hydrophila, respectively, as compared with lower efficacy from ultrasound and nanobubbles solutions alone (P>0.05). Additionally, the results of V. parahaemolyticus showed that the bacterial reduction was independent of the exposure time, while more A. hydrophila reduction was observed by increasing the exposure time.

In embodiments, ultrasound is applied for a period of time on the order of minutes, such as about 0, 5, 10, 15, 20, 25, 30, 35, 40, 45, 50, 55, or 60 minutes, or any range in between.

Materials and Methods

Bacterial Strain Preparation

Clinically isolated A. hydrophila was provided by Dr. David Crosby from Virginia State University, and V. parahaemolyticus, was isolated from sea water. Frozen stock cultures of the strains were streaked on agar media and incubated at 35 and 37° C. for 24 h, for V. parahaemolyticus and A. hydrophila, respectively. A loop of these cultures was transferred two successive times into 10 ml of tryptic soy broth and incubated at 37° C. and 35° C. (V. parahaemolyticus) for 18 h. 1 ml of the broth culture was pipetted into a 1.5 ml centrifuge tube and centrifuged at 12000 rpm for 2 minutes. Supernatant was discarded and the resultant pellets were resuspended with 1 ml of sterile phosphate buffer saline (PBS), and centrifuged at 12000 rpm for 2 minutes. This process was repeated twice, and the pellet from the second wash was resuspended in 1 ml sterile PBS. The population of bacteria in inoculum was approximately 109 CFU/ml.

Data Analysis for Examples 1-4

Each of the experiments described in the above examples were conducted three times with two replicates for each experiment (n=6) to ensure reproducibility. The results were expressed as the mean of the replicates±standard deviation. The significance of differences among the biofilm removal treatments was determined using one-way analysis of variance (ANOVA) and differences were considered significant at P<0.05. The significance of differences for anti-adhesion study was determined using t-test by Minitab 19 statistical software.

After collecting the SERS spectra from samples, pre-treatment was conducted using Unscrambler® X software (version 10.5) (CAMO Software, Oslo, Norway) by employing baseline correction, following by normalization and a smoothing. Atlμs mapping software was applied for mapping, image collecting and processing.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1-27. (canceled)

28. A method comprising:
exposing a substrate, a surface of a substrate, or a portion thereof, to a composition comprising nanobubbles, nanogas bubbles, and/or ultrafine bubbles of oxygen, pure oxygen, carbon dioxide, air, nitrogen, chlorine dioxide, octafluoropropane, and/or sulfur hexafluoride, or combinations thereof,
wherein the exposing is performed before, during or after exposure of the substrate, surface, or portion thereof to one or more single cell organism(s), algae, bacteria, yeast, mold, and/or virus(es); and
allowing the exposing to occur for a period of time sufficient for reducing, interfering with, alleviating, removing, and/or preventing adhesion of the single cell organism(s), algae, bacteria, yeast, mold, and/or virus(es) to the substrate, surface of the substrate, or portion thereof;
wherein the period of time is on the order of minutes.

29-31. (canceled)

32. The method of claim 28, wherein the substrate, the surface of the substrate or portion thereof is metal, stainless steel, mild steel, copper, copper-nickel, bronze, cast iron, aluminum, titanium, Teflon, plastic, Polypropylene, Polyvinyl chloride (PVC), Polystyrene, Polycarbonate, High Density Polyethylene (HDPE), Low Density Polyethylene (LDPE), Acrylonitrile butadiene styrene (ABS), Polyethylene terephthalate (PET), Polyurethane, nylon, glass, composite, concrete, fiber board, food or food products, animal feed, prepared foods, water for food production/preparation, meat, seafood, shellfish, oysters, clams, cockles, mussels, beef, pork, chicken, lamb, mutton, salmon, fish, produce, fresh produce, fruit, apples, grapes, pears, leafy greens, kale, spinach, lettuce, romaine lettuce, vegetables, juices from fruits and/or vegetables, legumes, rice, green beans, broccoli, carrots, celery, strawberries, blueberries, raspberries, onions, potatoes, wood, or combinations thereof.

33. The method of claim 28, wherein the bacteria are chosen from gram-positive bacteria, gram-negative bacteria, L. innocua, E. coli, or V. parahaemolyticus or combinations thereof.

34. The method of claim 28, wherein the composition comprises one or more sanitizers.

35. (canceled)

36. The method of claim 28, wherein the composition comprises electrolyzed water with a pH in the range of about 5-6.5.

37-40. (canceled)

41. The method of claim 28, wherein the composition comprises chlorine in the form of hypochlorous acid present in an amount up to about 500 ppm of the composition.

42-46. (canceled)

47. The method of claim 28, wherein the composition comprises chlorine in the form of free chlorine present in an amount of up to about 50 ppm of the composition.

48-50. (canceled)

51. The method of claim 28, wherein the single cell organism(s), algae, bacteria, yeast, mold, and/or virus comprises one or more of L. innocua, E. coli, A. hydrophila, V. parahaemolyticus bacteria, Campylobacter, Clostridium perfringens, Listeria, Listeria monocytogenes, noroviruses, human norovirus, rotaviruses, sapoviruses, adenoviruses, enteroviruses, astroviruses, Salmonella, Salmonella typhi (Typhoid), Bacillus cereus, Clostridium botulinum (Botulism), Hepatitis A, Hepatitis E, Shigella, Staphylococcus aureus, Toxoplasma, Vibrio Species Causing Vibriosis, Vibrio cholerae (Cholera), Vibrio parahaemolyticus, Vibrio vulnificus, Coronavirus, SARS, COVID, COVID-19, MERS, Nipah virus, Highly Pathogenic Avian Influenza (HPAI) virus, bovine spongiform encephalitis (BSE), Trichinosis, Scrapie, Alternaria, Aspergillus, Botrytis, Cladosporium, Fusarium, Geotrichum, Monilia, Manoscus, Mortierella, Mucor, Neurospora, Oidium, Oosproa, Penicillium, Rhizopus and Thamnidium, Aflatoxin, or combinations thereof.

52. A method for killing one or more microbe(s) comprising:
preparing a composition of gas bubbles comprising pure oxygen, oxygen, carbon dioxide, air, nitrogen, chlorine dioxide, octafluoropropane, and/or sulfur hexafluoride, or combinations thereof,
exposing the composition to one or more microbe(s); and
exposing the composition and microbe(s) to ultrasound.

53. The method of claim 52, wherein the gas bubbles comprise nanobubbles, nanogas and/or ultrafine bubbles.

54. (canceled)

55. The method of claim 52, wherein the one or more microbes comprise single cell organism(s), algae, bacteria, yeast, mold, and/or virus, or L. innocua, E. coli, A. hydrophila, V. parahaemolyticus bacteria, Campylobacter, Clostridium perfringens, Listeria, Listeria monocytogenes, noroviruses, human norovirus, rotaviruses, sapoviruses, adenoviruses, enteroviruses, astroviruses, Salmonella, Salmonella typhi (Typhoid), Bacillus cereus, Clostridium botulinum (Botulism), Hepatitis A, Hepatitis E, Shigella, Staphylococcus aureus, Toxoplasma, Vibrio Species Causing Vibriosis, Vibrio cholerae (Cholera), Vibrio parahaemolyticus, Vibrio vulnificus, Coronavirus, SARS, COVID, COVID-19, MERS, Nipah virus, Highly Pathogenic Avian Influenza (HPAI) virus, bovine spongiform encephalitis (BSE), Trichinosis, Scrapie, Alternaria, Aspergillus, Botrytis, Cladosporium, Fusarium, Geotrichum, Monilia, Manoscus, Mortierella, Mucor, Neurospora, Oidium, Oosproa, Penicillium, Rhizopus and Thamnidium, Aflatoxin, or combinations thereof.

56. The method of claim 52, wherein the exposing to ultrasound is performed for an amount of time sufficient to reduce the amount of microbe(s) or bacteria by up to about 99% and/or for a period of time less than or equal to about 15 minutes.

57. (canceled)

58. The method of claim 52, wherein the microbe is one or more of gram-positive bacteria, gram-negative bacteria, L. innocua, E. coli, V. parahaemolyticus, A. hydrophila, or combinations thereof.

59. (canceled)

60. A method for bacterial reduction comprising exposing one or more bacteria or microbe(s) and/or a substrate to a composition or solution comprising gas bubbles.

61-67. (canceled)

68. The method of claim 60, further comprising engineering the nanobubble/nanogas and/or ultrafine bubbles composition or solution by surface modification.

69. The method of claim 68, wherein the surface modification introduces one or more antimicrobial compounds chosen from polymers, phages, peptides, carbohydrates, lipids, fatty acids, alcohols, and/or ketones, or combinations thereof, to the nanobubble solution.

70. The method of claim 60, further comprising introducing a stabilizing agent to the nanobubble/nanogas and/or ultrafine bubbles composition or solution.

71. The method of claim 70, wherein the stabilizing agent comprises one or more antibodies, monoclonal antibodies, multispecific antibodies, human antibodies, humanized antibodies, camelised antibodies, chimeric antibodies, single-chain Fvs (scFv), single chain antibodies, Fab fragments, F(ab′) fragments, disulfide-linked Fvs (sdFv), anti-idiotypic (anti-Id) antibodies, epitope-binding fragments of antibodies, immunoglobulin molecules, immunologically active fragments of immunoglobulin molecules, molecules that contain an antigen binding site, IgG, IgE, IgM, IgD, IgA, IgY, IgG1, IgG2, IgG3, IgG4, IgA1, IgA2, one or more peptides, polypeptides, carbohydrates, hormones, steroids, polysaccharides, lipids, lipopolysaccharides, glycoproteins, lipoproteins, nucleoproteins, oligonucleotides, nucleic acids, phage, one or more members of Siphoviridae and/or Myoviridae, nanoparticles, or combinations thereof.

72. (canceled)

73. The method of claim 71, wherein the nanoparticles are tetrahedra, rods, prisms, cubes, stars, or core shell particles, or combinations thereof.

74. The method of claim 71, wherein the nanoparticles comprise ferromagnetic metals, metal alloys, iron-nickel, iron-platinum, cobalt-platinum, metal oxide, iron oxides, ferric oxides, Magnetite, Ferrites, Oxyhydroxides, Co₃O₄, polymers, poly ethylene glycol (PEG), chitosan, Poly diallyl dimethyl amine, Polyvinyl alcohol, Poly (4-vinylpyridine), Poly styrenesulfonate, Poly (maleic acid-co-olefin), Poly dimethylamine, Polyacrylic acid, Polyacrylamide, Poly aspartic acid, Diphosphate, poly ethylenimine, Oleic acid, Dextran-sulfate, Phosphate-starch, lipids, Carboxy methyl dextran, DNA, RNA, short single chain DNA, aptamers, or combinations thereof.

75-83. (canceled)
